(19) United States
(12) Patent Application Publication
(10) Pub. No.: US 2016/0280136 A1
(43) Pub. Date: Sep. 29, 2016

(54) ACTIVE-TRACKING VEHICULAR-BASED SYSTEMS AND METHODS FOR GENERATING ADAPTIVE IMAGE

(71) Applicant: Guy M. Besson, Broomfield, CO (US)

(72) Inventor: Guy M. Besson, Broomfield, CO (US)

(21) Appl. No.: 15/145,701

(22) Filed: May 3, 2016

Related U.S. Application Data
(63) Continuation-in-part of application No. 14/639,322, filed on Mar. 5, 2015.
(60) Provisional application No. 62/156,670, filed on May 4, 2015.
(60) Provisional application No. 61/997,471, filed on May 9, 2014.
(60) Provisional application No. 61/948,471, filed on Mar. 5, 2014.

(51) Int. Cl. B60R 1/00; G06K 9/00

(52) U.S. Cl. CPC B60R 1/00; G06K 9/00845; B60R 2300/304; B60R 2300/102; B60R 2300/605; B60R 2300/8046

(57) ABSTRACT

An active-tracking vehicular-based system for generating an adaptive mirror-like image includes a position sensing module for determining the position of an observer relative to a virtual or physical observer surface, a gaze sensing module for determining the observer gaze direction relative to the observer surface, a virtual mirror surface, and a camera module for generating the adaptive image based upon the position and gaze direction determined respectively by the position sensing and gaze direction sensing modules, as the image would have been experienced by the observer with essentially complete view of the vehicle surroundings looking backwards with respect to the vehicle direction of motion. In particular, an active-tracking vehicular-based method for generating a mirror image includes (a) determining the position of an observer and observer gaze direction relative to a surface, (b) capturing at least one image, and (c) generating, from the at least one image, the mirror image as the mirror image would have been experienced by the observer if the virtual mirror surface had been a mirror.

### CROSS REFERENCE TO RELATED APPLICATIONS

This application claims benefit of priority to U.S. Provisional Patent Application Ser. No. 62/156,670, filed May 4, 2015, and is a continuation-in-part of U.S. patent application Ser. No. 14/639,322, filed Mar. 5, 2015, which claims benefit of priority to U.S. Provisional Patent Application Ser. No. 61/948,471, filed Mar. 5, 2014, and to U.S. Provisional Patent Application Ser. No. 61/997,471, filed May 9, 2014. Each of the aforementioned applications are incorporated herein by reference in its entirety.

### BACKGROUND

This disclosure pertains to the field of vehicle operation and navigation.

More particularly, this disclosure pertains to sensing spatial and other information relating to the vehicle's surroundings and adaptively displaying visual information to the operator.

### SUMMARY

In an embodiment, an active-tracking vehicular-based system for generating an adaptive image, including a mirror-like image, includes a position-sensing module for determining the position of an observer relative to a display surface. The adaptive image may be the mirror-like image. The system further includes video imaging, computer, and software to determine the direction in which the observer is looking (observer gaze direction). The active-tracking vehicular-based system further includes a camera module for generating a mirror-like image based upon the position determined by the position-sensing module and the gaze-determination module, as the mirror-like image would have been experienced by the observer if the display surface had been a mirror or part of a mirror surface.

Alternatively, or in addition, the active-tracking vehicular-based system may provide low-intensity light illumination of the observer or driver, so that position and gaze determination are possible in nighttime driving conditions. Such low-intensity illumination may be at wavelengths that are not ordinarily discerned by the human visual system, such as infrared radiation, for example.

In an embodiment, an active-tracking vehicular-based system for generating an adaptive image, including a mirror-like image, includes a position-sensing module for determining the position of an observer relative to a virtual or physical observation surface. The adaptive image may be the mirror-like image. The system further includes an addressable digital display and display surface and video imaging, computer, and software to determine the direction in which the observer is looking (observer gaze direction) with respect to the observation surface. The active-tracking vehicular-based system further includes a camera module comprising one or more video cameras and an image generation module for generating an image based upon the position determined by the position-sensing module and the gaze direction determined by the gaze-determination module, as the image would have been experienced by the observer if the display surface had been a mirror or part of a mirror surface. The image generation module adaptively accounts for the observer's position and general gaze direction with respect to the observation surface, the observation surface possibly containing the image display surface but generally distinct and possibly separate from the display surface.

In an embodiment, an active-tracking vehicular-based system for generating an adaptive image, including a mirror-like image, includes a position-sensing module for determining the position of an observer relative to a virtual or physical observation surface. The adaptive image may be the mirror-like image. The system further includes an addressable digital display and display surface and video imaging, computer, and software to determine the direction in which the observer is looking (observer gaze direction) with respect to the observation surface. The active-tracking vehicular-based system further includes a camera module comprising one or more video cameras and an image generation module for generating an image based upon the position determined by the position-sensing module and the gaze direction determined by the gaze-determination module, as the image would have been experienced by the observer if the display surface had been a mirror or part of a mirror surface. The (virtual) mirror surface may be of much larger extent than the active display surface, and may comprise several different surfaces of known dimensions, shapes, and locations (such as on the left and right of the vehicle). The image generation module adaptively accounts for the observer's position and general gaze direction with respect to the observation surface. The observation surface may contain the image display surface but is generally distinct and possibly separate from the display surface.

In an embodiment, an active-tracking vehicular-based system for generating an adaptive image, including a mirror-like image, includes a position-sensing module for determining the position of an observer relative to a virtual or physical observation surface. The adaptive image may be the mirror-like image. The system further includes an addressable digital display and display surface and video imaging, computer, and software to determine the direction in which the observer is looking (observer gaze direction) with respect to the observation surface. The active-tracking vehicular-based system further includes a camera module comprising one or more video cameras and an image generation module for generating an image based upon the position determined by the position-sensing module and the gaze direction determined by the gaze-determination module, as the image would have been experienced by the observer if the observer had been generally speaking in the direction opposite the direction of travel. The image generation module adaptively accounts for the observer's position and general gaze direction with respect to the observation surface, the observation surface possibly containing the image display surface but generally distinct and possibly separate from the display surface.

In another embodiment, the active-tracking vehicular-based system further merges video data and imagery to provide the observer with a view of the immediate surroundings of the vehicle and the environment within which it moves.

In another embodiment, a display system includes an addressable luminous display, a computer, at least one position sensor, and at least one optical camera or sensor. The system determines the relative orientation of an observer with respect to a virtual or physical observation surface, determines the observer's gaze direction with respect to the observation surface and generates an image from the collection of input optical camera(s), such that an image presented to the observer is similar to the image that would be created were the display surface be a mirror; wherein the mirror may be a mirror of extend, shape and location significantly different than the extent, shape and location of the actual image display. The generated image is synthesized by a computer from input optical cameras and input observer relative position and gaze direction with respect to the observation surface. This is achievable either by controlling and orienting one or a plurality of optical sensor as a function of the observer's position with respect to the display; or by acquiring one or a plurality of images from one or a plurality of fixed or controllable image sensors, and synthesizing one image for display from the plurality of acquired images as a function of the estimated observer's position and gaze direction and the known positions of the various optical sensors.

Further, an active tracking and adaptive display, such as disclosed in the present invention, enables the combination of various image streams; such that the adaptive image synthesized by the system in response to the detection, characterization, and location determination of an observer and observer gaze, may be combined with other image streams: such as for example image sequences obtained from a data base; or in another example, an image sequence remotely acquired and transmitted substantially in real time to the active tracking vehicular system; or in another example, an overlay image frame containing graphics information pertaining to the vehicle immediate surroundings. In such a way, an “enhanced reality” image sequence is presented to the observer that accounts for the observer position with respect to the display, and merges or synthesizes an associated “mirror image” with an image stream either previously recorded or recorded somewhere else and transmitted substantially in real-time to the active display system. In such an embodiment, feature(s) from one input image stream (say, for illustration, the pre-recorded or remotely acquired image stream) are extracted and merged with the input image stream generated by the active tracking part of the system; in such a way that a virtual-reality type image sequence is generated for presentation to the system observer/viewer. As an illustration, navigational data relating to the vehicle position, speed, and environment may be provided in the form of an “image overlay” that may be merged with the synthesized adaptive image data. Herein, “image overlay” refers to the presentation of information, not necessarily image information, within a digitized image. Furthermore, proximity information of other vehicles or obstacles may also be presented on an image overlay to be merged with the adaptive image data. The other image stream(s) may provide a three-dimensional rendition of the environment within which the vehicle operates, and merges the mirror data within the three-dimensional space rendition to provide the vehicle operator an enhanced perception of the dynamic environment within which the vehicles travels. Such three-dimensional rendering may include “look-ahead” data, information relating to the likely trajectories of near-by object(s) and vehicle(s), and/or any warning generated therefrom.

In one implementation, the observation surface is segmented and enables the determination of the observer gaze direction toward a “mirror area” on the observation surface. Upon such a determination, the “mirror display” is activated and its luminous intensity is increased.

In one embodiment, a semi-transparent display is provided, such that an adaptive mirror image, such as discussed above, may be displayed on the semi-transparent display. This semi-transparent display may be substantially placed in front of the driver, for example directly on the vehicle windshield.

In an embodiment, an active-tracking vehicular-based method for generating a mirror image includes determining the position of an observer relative to both an observation surface and a virtual mirror surface. The active-tracking vehicular-based method further includes (a) capturing at least one image and (b) generating, from the at least one image, the mirror image as the mirror image would have been experienced by the observer if the virtual mirror surface had been a mirror. The system tracks the observer's gaze and adaptively changes the displayed image as a function of observer position and gaze direction. The system may provide variable image magnification as a function of the observer's position and gaze direction with respect to the observation surface.

In one embodiment, a method for generating an image for presentation on an addressable display includes (a) sensing the relative orientation of an observer with respect to an observation surface, (b) sensing the observer's gaze direction with respect to the observation surface, and (c) generating an image from one or more optical sensor(s) to mimic the operation of a mirror. The method generates a synthetic image in response to input optical camera(s) and relative observer positions and orientations. The synthetic image is presented on the addressable display. From the point of view of the observer, the synthetic image is representative of (a) a scene that would be presented were the addressable display replaced, at least in part, by a passive optical mirror, or (b) a scene that would be presented to the observer by a passive optical mirror of known shape and of known location with respect to the active display.

In one embodiment, a method of generating an image for presentation on an addressable display includes (a) sensing the relative orientation of an observer with respect to an observation surface, (b) sensing the observer's gaze direction with respect to the observation surface, and (c) generating an image from one or more optical sensor(s) to mimic the operation of a mirror. The method is applicable to vehicular travel, vehicular control, and/or navigation. The method generates a synthetic image in response to input optical camera(s) and relative observer positions and orientations and observer gaze direction. The synthetic image is presented on the addressable display. From the point of view of the observer, the synthetic image is representative of a scene that would be presented were the observer looking into a virtual mirror surface. This virtual mirror surface may be significantly larger than the actual size of the active display, and/or have shape differently from that of the active display.

In one embodiment, a method of generating an image for presentation on an addressable display includes sensing the relative orientation of an observer with respect to an observation surface, sensing the observer's gaze direction with respect to the virtual or physical surface, and generating an image from one or more optical sensor(s) to mimic the operation of a wide angle camera. The method is applicable to vehicular travel, vehicular control, and/or navigation. The method generates a synthetic image in response to input optical camera(s) and relative observer positions and orientations. The synthetic image is presented on the addressable display. From the point of view of the observer, the synthetic image is representative of a scene that would be presented were the observer to look back generally in a direction opposite the direction of vehicular travel and obtain a wide-angle view of the vehicle immediate surroundings as available through wide-angle optics such as a fish-eye lens.

Alternatively, or in addition, the synthesized image is processed by computer means in any of a variety of ways to present to the observer an enhanced image as compared to that a passive mirror or optical camera(s) would provide. For example, the displayed image may have been digitally processed to enhance resolution; to increase luminosity of selected features; or to automatically segment and present specific image features; or to present an un-warped wide-angle view as a result of the processing of image data provided by a wide angle lens, such as a fish-eye lens, or a set of such lenses. Further, the synthesized image may display light information acquired in light wavelengths that the human eye typically does not discern, such as infra-red light.

In yet another embodiment, a computer-readable medium (e.g., non-transitory memory) is provided. The medium is encoded with machine-readable instructions that, upon execution by a processor, instruct a computer to generate a synthetic image from at least one optical camera and from an input direction representative of the relative position of an observer and the observer gaze direction with respect to an observation surface. In one such embodiment, the computer also records the synthetic image or image sequence generated by the active tracking vehicular system. In another such embodiment, the computer also records a synthetic image or image sequence generated by merging the active tracking adaptive image generated by the system with another image either previously recorded or locally or remotely acquired. The recording thus enables later enhanced-reality or virtual-reality rendition by merging the recorded video stream with a second video stream; the second video stream being either synthesized by the system as described above, obtained from a second recording, or remotely acquired and transmitted to the system. The second video stream may contain image data or non-image data overlayed in image frames.

Additionally, the present invention may also generate, and optionally display, three-dimensional information as a means to further improve upon the quality of the life-like experiences made possible through the systems and methods outlined herein. In certain implementations of the systems and methods disclosed herein, the adaptive image generated includes spatial information related to the vehicle surroundings substantially on all sides of the vehicle. The image generation module adaptively accounts for the observer's position and general gaze direction with respect to an observation surface, the observation surface possibly containing an image display surface but generally separate from the display surface.

### BRIEF DESCRIPTION OF THE DRAWINGS

FIG. 1 illustrates an active-tracking vehicular-based system for generating, and optionally displaying, an adaptive image representing, at least in part, a scene corresponding to immediate vehicle surroundings, according to an embodiment.

FIG. 2 is a block diagram for the active-tracking vehicular-based system of FIG. 1, according to an embodiment.

FIG. 3 illustrates an active-tracking vehicular-based system for generating, and optionally displaying on a plurality of active displays, an adaptive image representing, at least in part, a scene corresponding to immediate vehicle surroundings, according to an embodiment.

FIG. 4 illustrates an active-tracking vehicular-based system for generating, and optionally displaying on an internal active display, an adaptive image representing, at least in part, a scene corresponding to immediate vehicle surroundings, according to an embodiment.

FIG. 5 illustrates an active-tracking vehicular-based system for generating, and optionally displaying on an active semi-transparent display, an adaptive image representing, at least in part, a scene corresponding to immediate vehicle surroundings, and according to an embodiment.

FIG. 6A illustrates an active-tracking vehicular-based system for, when the observer's gaze intersects a virtual or physical surface, generating and displaying on an active display an adaptive synthesized image representing, at least in part, a scene corresponding to immediate vehicle surroundings, according to an embodiment.

FIG. 6B illustrates an extension of the system of FIG. 6A, wherein the position at which the adaptive image is displayed, as well as the brightness of the adaptive image, adapt to the gaze direction of the observer, according to an embodiment.

FIG. 7 illustrates an active-tracking vehicular-based method for generating, and optionally displaying, an adaptive image representing, at least in part, a scene corresponding to immediate vehicle surroundings, according to one embodiment.

FIG. 8 illustrates an active-tracking vehicular-based system integrated with a vehicular screen such as a windshield, for displaying an adaptive image on the screen when the observer's gaze intersects a second virtual or physical surface, according to an embodiment.

FIG. 9 illustrates an active-tracking vehicular-based system for generating and displaying an adaptive image that includes (a) image data pertaining to vehicle navigation and (b) a view of immediate vehicle surroundings, according to an embodiment.

FIG. 10 illustrates an active-tracking vehicular-based method to generate an adaptive image of the vehicle's immediate surroundings, according to an embodiment.

FIG. 11 illustrates an active-tracking vehicular-based system, with merge and record functions, for generating and optionally displaying an adaptive image that includes (a) a view of immediate vehicle surroundings, for example such as would be provided by a mirror, and (b) forward view imagery, according to another embodiment.

FIG. 12 illustrates another active-tracking vehicular-based system, with merge and record functions, for generating and optionally displaying an adaptive image that includes (a) a view of immediate vehicle surroundings, for example such as would be provided by a mirror, and (b) overlay image graphics information, according to an embodiment.

FIG. 13 illustrates an active-tracking based system for generating, and optionally displaying, a mirror image representing a scene that appears, to an observer, to be that reflected by a passive optical mirror, according to an embodiment.

FIG. 14 illustrates an active-tracking based method for generating, and optionally displaying, a mirror image representing a scene that appears, to an observer, to be that reflected by a passive optical mirror, according to an embodiment.

FIG. 15 illustrates a “honeycomb” camera module having a plurality of camera devices arranged on a curved surface and oriented along different directions, according to an embodiment,

FIG. 16 illustrates an active-tracking based system for generating, and optionally displaying, a mirror image, wherein the active-tracking based system includes a rotatable camera module, according to an embodiment.

FIG. 17 illustrates an active-tracking based system for generating, and optionally displaying, a mirror image, wherein the active-tracking based system includes a rotatable position sensor and a plurality of camera devices, according to an embodiment.

FIG. 18 illustrates an active-tracking based system for generating, and optionally displaying, a mirror image, wherein the active-tracking based system includes a rotatable camera module and a rotatable position sensor, according to an embodiment.

FIG. 19 illustrates another active-tracking based system for generating, and optionally displaying, a mirror image, according to an embodiment.

FIG. 20 illustrates yet another active-tracking based system for generating, and optionally displaying, a mirror image, according to an embodiment.

FIG. 21 illustrates an active-tracking based method for generating, and optionally displaying, a mirror image, using at least one rotatable camera device, according to an embodiment.

FIG. 22 illustrates an active-tracking based method for generating, and optionally displaying, a mirror image, using a plurality of camera devices, according to an embodiment.

FIG. 23 illustrates an active-tracking based system for generating, and optionally displaying, a mirror image, and which includes merge and record functions, according to an embodiment.

FIG. 24 illustrates another active-tracking based system for generating, and optionally displaying, a mirror image, and which includes merge and record functions, according to an embodiment.

FIG. 25 illustrates yet another active-tracking based system for generating, and optionally displaying, a mirror image, and which includes merge and record functions, according to an embodiment.

FIG. 26 illustrates a method for merging two input images, according to an embodiment.

FIG. 27 illustrates a live-video conference system that includes two communicatively coupled active-tracking based systems for displaying a mirror image, wherein each active-tracking based system has merge and record functions, according to an embodiment.

FIG. 28 illustrates an active-tracking based method for generating live video conference imagery, according to an embodiment.

FIG. 29 illustrates generation of a three-dimensional model of an observer by an active-tracking based system of the live video conference system of FIG. 27, according to an embodiment.

### DETAILED DESCRIPTION OF THE EMBODIMENTS

Disclosed herein are active-tracking vehicular-based systems and methods that generate and optionally display, adaptive images or image sequences representing a scene that appears, in one embodiment, to an observer, to be that reflected by a passive optical mirror; or a scene synthesized from one or a plurality of video inputs and image graphics inputs. The active-tracking vehicular-based systems and methods determine the position of the observer and the direction of the observer's gaze with respect to a virtual or physical observation surface to generate the adaptive image or image sequence, and may produce life-like imagery for a display, such as an addressable computer displays. The active-tracking vehicular-based systems are configured to be integrated with a vehicle, such that the system may display, to an operator of the vehicle, adaptive images (or image sequences) that include imagery of the vehicle's immediate surroundings and, optionally, other information relevant to the vehicle operator.

An optical mirror is a familiar object throughout human society in any place in the world. Optical mirrors have been known since antiquity. Herein, the terms “optical mirror” and “mirror” are used interchangeably. An optical mirror brings light in a room, allows self-observation, and brings a sense of depth to many small rooms. In vehicular application, a mirror allows viewing traffic and surroundings generally located behind or on the sides of the vehicle, outside the driver/operator's immediate perception when looking at the road ahead. The presently disclosed active-tracking vehicular-based systems and methods provide a mode of operation of an active, addressable display, such that the display presents to the observer a scene similar to that provided by one or a collection of optical mirror(s), whether the mirror(s) surface(s) is/are flat or not. In one embodiment, the mirror is of shape, size, and/or location significantly different from the shape, size, and location, respectively, of the active display.

In one example, the active-tracking vehicular-based systems and methods disclosed herein produce an image that presents, to an observer, the mirror image that the observer would have experienced if the display had been a passive optical mirror. In another example, the active-tracking vehicular-based systems and methods produce an image that presents, to an observer, the mirror image that the observer would have experienced if the observer had been looking into a passive optical mirror of known shape and location with respect to the display.

Also disclosed herein are active-tracking vehicular-based systems and methods that generate a mirror image, or mirror image sequence, representing a scene that appears, to an observer, to be that reflected by a passive optical mirror, and merge such a mirror image with a second image or image sequence, including image graphics overlays. In one implementation, such active-tracking vehicular-based systems and methods are used to generate an augmented reality or virtual reality experience, whereby an image or rendition of a scene is generated or synthesized from a multiplicity of image and other inputs, to create in an observer the illusion or semblance that the displayed scene is real.

In certain embodiments, the active-tracking vehicular-based systems and methods discussed above generate, and optionally display, three-dimensional images or three-dimensional renditions of the immediate surroundings of the vehicle.

In certain embodiments, the active-tracking vehicular-based systems and methods discussed above generate vehicle surrounding imagery similar to what the observer would have seen by looking into a rear-view mirror or collection of such mirrors, and merge such adaptive image with a forward-looking view, thus enabling the observer to obtain the “rear-view” mirror functionality without discontinuity in the observer's perception of forward looking scene.

In certain embodiments, the presently disclosed active-tracking vehicular-based systems and methods provide a mode of operation of an active, addressable display, such that the display presents to the observer a scene similar to that provided by one or a set of video inputs, generally oriented in a direction opposite the direction of travel, but also including scene elements from the vehicle immediate surroundings. The active tracking vehicular-based system monitors the position and orientation of the observer, the observer's head, and/or the observer's eyes. Furthermore, the active tracking vehicular-based system monitors the direction of the observer's gaze, and adaptively synthesize a scene in response. The synthesized scene presents information about the vehicle immediate surroundings, generally covering the angles that are not directly sensed by the observer visual system. Optionally, the active tracking vehicular-based system further merges graphical information related to the vehicle current position, its current environment, and external factors that are relevant to its motion in the coming instants; the time frame of relevance being determined in part by the vehicle velocity, the nature of the environment, and the relative velocities of objects nearby.

Herein, the term “observation surface” refers to a virtual or physical surface, possibly including display surface but generally distinct from it, in reference to which the observer's position and gaze direction is determined. The observation surface may contain various sub-areas; such as a sub-area corresponding to a mirror, virtual or physical; a forward-looking area, where the observer is normally looking in the operation of a vehicle. From knowledge of the observer position, head orientation, and gaze direction with respect to the observation surface, it is determined which of the sub-surface area the observer is looking at. An image is adaptively generated and displayed as a function of this information. The gaze direction is determined, for example from the orientation of the observer's head, or the actual gaze direction of the observer's eyes.

Herein, the terms “display”, “active display”, “visual display device,” “addressable display,” refer to any type of device such as CRT (cathode ray tube) monitor, LCD (liquid crystal display) screens, OLED (organic light emitting diodes) displays, plasma screens, projected image, indium gallium zinc oxide (IGZO) high-density displays, etc., used to visualize image information, such as image data represented in a computer as a grid or vector or array of luminous intensity values, and which is controlled by a computer as opposed to a “passive display” such as a light-reflecting surface, picture, or mirror. These terms also refer to addressable digital screens that may present a flat or curved surface of any desirable shape; and also refers to semi-transparent display technologies that enable the perception of an optical scene there-through, whether in active superposition of digital imagery or not.

Herein, the term “observer” refers to one of a human observer, an animal, a moving object, and more generally the trajectory of a moving (or stationary) point in space; such point being either traceable in space through some specific property (such as an electromagnetic emitter; light reflective property; etc.), or its trajectory (or location) pre-defined.

Herein, the terms “optical sensor,” “optical camera,” “camera”, and “camera device” are used interchangeably and are not meant to be limited to the part of the electromagnetic spectrum that is directly visible by a human observer. Thus, a camera may be sensitive in the infrared region of the spectrum, for example. A camera may integrate an optical lens or combination of lenses with, for example, a charge-coupled device (CCD) or complementary-metal-oxide-semiconductor (CMOS) chip. Such a camera may allow image formation and digital recording in a compact format.

Herein, the term “camera module” refers to one or more camera, including possibly fish-eye cameras, wide-angle cameras, and controls. Cameras may be mounted on various part of the vehicle so as to provide substantially enhanced rear-mirror view functionality, in one embodiment. In another embodiment, cameras provide substantially a complete view of the vehicle surroundings on at least two sides and a rear view. In yet another embodiment, cameras also provide forward-view imagery.

Herein, a “controller” is not limited to just those integrated circuits referred to in the art as a controller, but broadly refers to a computer, a processor, a microcontroller, a microcomputer, a programmable logic controller, an application specific integrated circuit, and/or any other programmable circuit. Examples of a mass storage device include a nonvolatile memory, such as a read-only memory (ROM), and a volatile memory, such as a random access memory (RAM). Other examples of a mass storage device include a floppy disk, a compact disc-ROM (CD-ROM), a magneto-optical disk (MOD), an optical memory, a digital versatile disc (DVD), a solid-state drive memory.

Herein, the terms “observer's gaze”, “gaze”, “gaze direction”, “gaze vector” are used interchangeably and refer to the direction in which the observer is looking. More specifically, from the knowledge of the observer's position and looking direction, it is possible to calculate both an observation focus point on or around a display, and also the angles of the observation direction or gaze with respect to the display or nearby surfaces. It is understood that the human visual system properties enable the perception of a relatively wide-angle scene, even when a direction of focus is clearly set. Thus, both the precise gaze direction and the effective “aperture” determine the amount of depth that can be clearly perceived in a scene. Furthermore, the human visual system enables the perception of events, such as object motion, that occur at periphery of the field of view.

Herein, the terms “adaptive mirror image,” “adaptive image,” “mirror-like image,” “enhanced mirror-like image,” “synthesized image,” refer to an image synthesized by the active-tracking vehicular-based system and including (a) elements of an image that would be obtained by a passive mirror, (b) more comprehensive information, such as pertains to the vehicle immediate environment on all sides, for example forward-looking information relating to the spaces into which the vehicle is about to evolve and any other objects therein and their relative velocities and/or graphical overlay image data. The terms are also used to refer to synthesized images that do not contain any part of a passive mirror image, but do generally provide at least in part the functionality of a rear-view mirror image: to provide a view or rendition of the environment surrounding a vehicle on its sides and back or part thereof.

In one embodiment, the invention described herein replaces normal/standard mirror surface with an active tracking and extended-mirror display system, and merges the extended-mirror image with other information as relevant to navigation/driving.

In one embodiment, the systems and methods of the present invention include image processing for three-dimensional rendition of distance/proximity of other vehicles nearby.

In one embodiment, the image presented in the digital display is adaptive with respect to vehicular data and human observer data: where the observer/driver looks; where his eyes are located and the gaze direction. Sensors, including position and video sensors, may be provided internally and/or externally to the vehicle.

In one embodiment, sensors monitoring a human observer, such as a vehicle operator, for position/gaze may also provide feedback as to state of the observer, such as drowsiness.

In one embodiment, the system and method can provide various amount of magnification as a function of user setting. Magnification may be a function of the observer distance and/or motion toward or away from the screen or a virtual or physical surface.

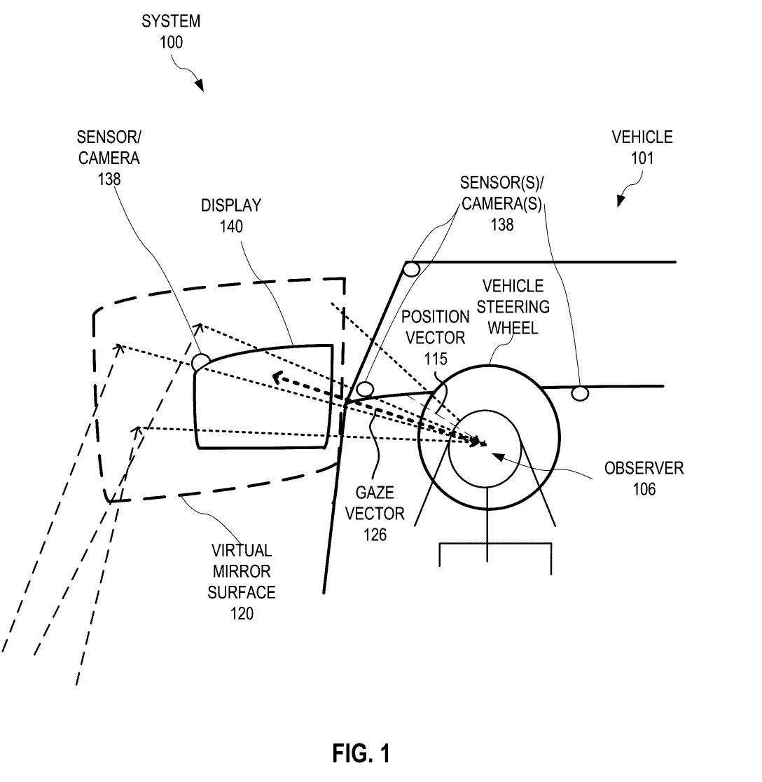

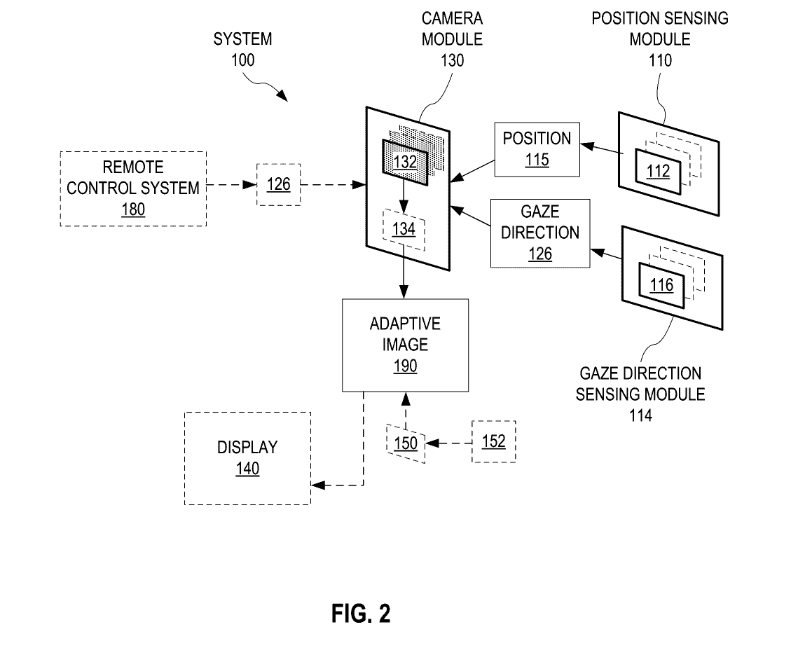

FIG. 1 illustrates one exemplary active-tracking vehicular-based system 100 for generating, and optionally displaying, an adaptive image 190 representing a scene that appears in one embodiment, to an observer 106, to be that reflected by a passive optical mirror located at a surface 120. FIG. 1 shows system 100 as implemented in a vehicle 101, and observer 106 is, for example, an operator of vehicle 101. FIG. 2 is one exemplary block diagram of active-tracking vehicular-based system 100. FIGS. 1 and 2 are best viewed together. System 100 generates adaptive image 190 such that adaptive image 190 shows a synthesized scene presenting information about the immediate surroundings of vehicle 101, generally covering the angles that are not directly sensed by the visual system of observer 106. Specifically, system 100 generates an adaptive image 190 that represents what observer 106 would see if virtual mirror surface 120 was replaced by a passive mirror, wherein this passive mirror may have known light reflecting, refracting, attenuating, and/or transmitting properties, and wherein such refracting, attenuating, transmitting properties may be position-dependent on the virtual mirror surface 120.

Optionally, system 100 further merges, into adaptive image 190, graphical information related to the current position/environment of vehicle 101, and/or external factors that are relevant to motion of vehicle 101 in the coming instants; the time frame of relevance being determined in part by the velocity of vehicle 101, the nature of the environment, and the relative velocities of objects nearby.

As shown in FIG. 2, system 100 includes a position sensing module 110, a gaze direction sensing module 114, and a camera module 130. Position sensing module 110 determines the position 115 of observer 106 relative to virtual mirror surface 120. Virtual mirror surface 120 may be external and/or internal to vehicle 101 and, for example, be located at or near a side view mirror of vehicle 101 or on a portion of a windshield of vehicle 101. In one embodiment, position sensing module 110 includes one position sensor 112 that senses observer 106 determines the position of observer 106 relative to surface 120 (i.e., position vector 115). In another embodiment, position sensing module 110 includes a plurality of position sensors 112 that cooperate to sense observer 106 and determine the position of observer 106 relative to surface 120. Gaze direction sensing module 114 includes one or more sensors that determine gaze direction 126 of observer 106, for example based upon determination of the head orientation of observer 106 or based upon direct sensing of the gaze direction of the eyes of observer 106. Camera module 130 includes at least one camera device 132 configured to capture an image. Each camera device 132 may include an optical lens and a digital image sensor. Camera module 130 may further include an image generator 134 that processes one or more images captured by camera device(s) 132 to generate an output image. Camera module 130 is communicatively coupled with position sensing module 110 and gaze sensing direction module 114. Optionally, system 100 further includes one or both of display 140 and an image processing module 150. Examples of camera module 130, camera device 132, position sensor 112, and display 140 are discussed in the section entitled “Active-tracking based systems and methods for generating mirror image” (see below). Position sensor(s) 112 and/or gaze direction sensor(s) 116 may illuminates the face of observer 106, so that position 115 and gaze direction 126 determination may be completed in a low external light environment, such as during nighttime vehicular operation. Such low-intensity illumination may be done via infra-red light, so as not to interfere with the observer's visual system.

FIG. 1 shows position sensing module 110, gaze direction sensing module 114, and camera module 130 collectively as sensors/cameras 138. Camera module 130 may be implemented with internal and/or external (relative to vehicle 101) camera device(s) 132 that generally provide views of the immediate surroundings of vehicle 101. In one example, camera module 130 is implemented with a rear-facing camera device 132 located at display 140 and externally to vehicle 101. Other camera device(s) 132 may be situated elsewhere on the vehicle as necessary to substantially provide a complete or partial view of the vehicle's immediate surroundings. Without departing from the scope hereof, sensors/cameras 138 may be located differently than shown in FIG. 1. Furthermore, although shown as occupying four different positions in FIG. 1, sensors/cameras 138 may be distributed over fewer or more positions, for example a single position. In one implementation, sensor/camera 138 shown in FIG. 1 as being located at display 140 is a rear-facing camera device 132.

In one embodiment, system 100 includes display 140 for displaying adaptive image 190. In another embodiment, system 100 does not include display 140 but is configured to cooperate with display 140 (for example a third-party display) to display adaptive image 190 thereupon. Optionally, system 100 includes a remote control system 180. System 100 may further include an image processing module 150.

Surface 120 may coincide with a physical surface, such as the surface of an addressable luminous display 140, or be a virtual mirror surface of different shape, extent, size, and/or location as compared to display 140. Shown in FIG. 1 as coinciding at least in part with display 140, virtual surface 120 may be, at least in part, different from the surface of display 140, without departing from the scope hereof. Additionally, surface 120 may have shape different from that shown in FIG. 1 and/or be curved. Furthermore, surface 120 may include two or more separate surfaces, each of known position and orientation. Surface 120 may represent all of the surface of display 140, a sub-portion of the surface of display 140, or several sub-portions of the surface of display 140. Display 140 is not necessarily flat, nor is display 140 necessarily rectangular. Display 140 may be comprised of several surfaces, each of known position and orientation.

Adaptive image 190, generated by system 100, adaptively depends on the location and gaze direction 126 of observer 106. In one example, variable amount of magnification of the adaptive image is generated in response to the observer moving closer or farther away from display surface; such adaptive magnification may be at least partly defined by user settings. System 100 may determine gaze direction 126 based upon the orientation of the head of observer 106 and/or the actual gaze direction of the eyes of observer 106.

Adaptive image 190 may also include dynamic overlay graphics data. Such graphics may present information relevant to the immediate vehicle environment, and may include “look-ahead” information data based on the respective velocities of the vehicle and of any object in the relevant look-ahead vicinity.

In operation, position sensing module 110 determines position 115 of observer 106 relative to virtual mirror surface 120, for example as discussed in the section entitled “Active-tracking based systems and methods for generating mirror image” (see below). Gaze direction sensing module 114 uses sensor(s) 116 to determine gaze direction 126 of observer 106. Camera module 130 uses camera device(s) 132 to capture at least one image and further generates adaptive image 190 therefrom. Camera module 130 may output, as adaptive image 190, an image captured by camera device(s) 132, or camera module 130 may utilize image generator 134 to process one or more captured images to generate adaptive image 190 therefrom, as discussed in the section entitled “Active-tracking based systems and methods for generating mirror image” (see below). When included, display 140 displays at least a portion of adaptive image 190 on at least a portion of display 140.

In certain embodiments, image processing module 150 merges adaptive image 190 with another image 152 to produce a merged image, and (b) display 140 displays this merged image. Without departing from the scope hereof, system 100 may generate the merged image without displaying it.

In certain embodiments, camera module 130 is communicatively coupled with a remote control system 180 that specifies gaze direction 126. This is applicable, for example, to a scenario wherein observer 106 is a point in space having a predefined location or trajectory. In one example, remote control system 180 communicates a gaze direction 126 corresponding to a view of interest. In another example, remote control system 180 communicates a series of gaze directions 126 to perform a raster scan. This raster scan may serve to search, and optionally locate, an object of interest such as a human observer 106. After locating this object of interest, using the raster scan, system 100 may proceed to actively track this object of interest. Remote control system 180 may replace one or both of position sensing module 110 and gaze direction sensing module 114, without departing from the scope hereof.

Observer 106 may be located at any position 115 relative to virtual mirror surface 120, as long as the reflection of the associated gaze direction 126 off virtual mirror surface 120 is viewable by at least one camera device 132.

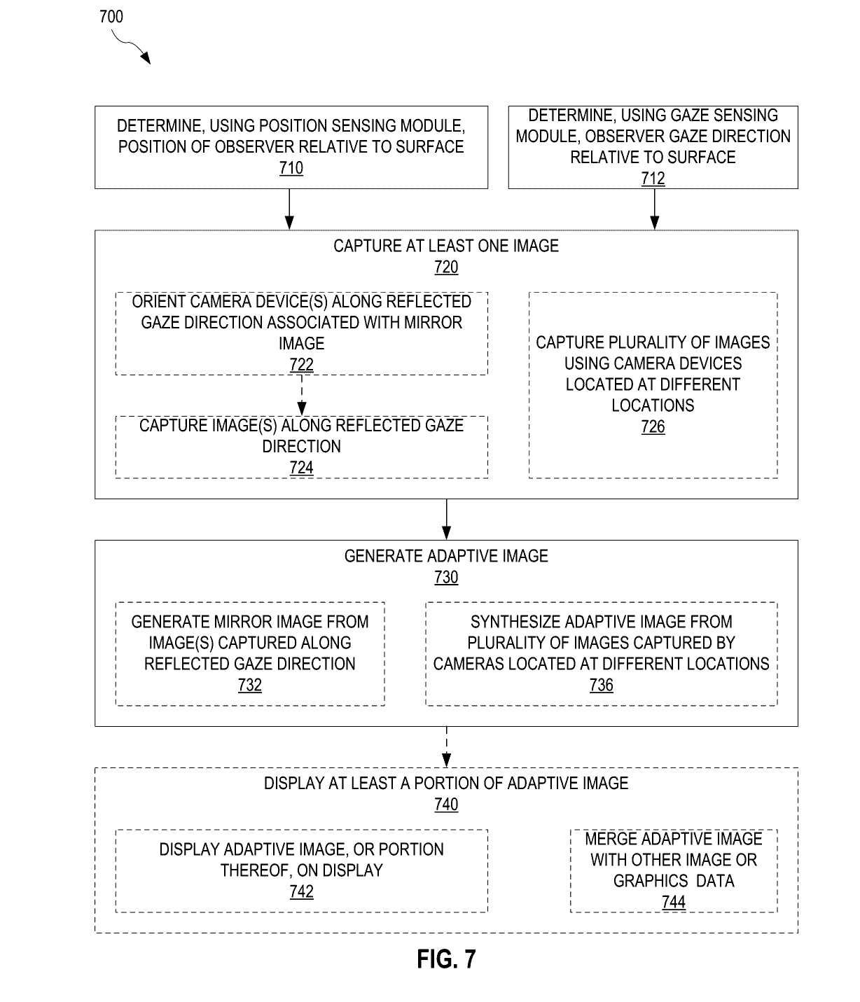

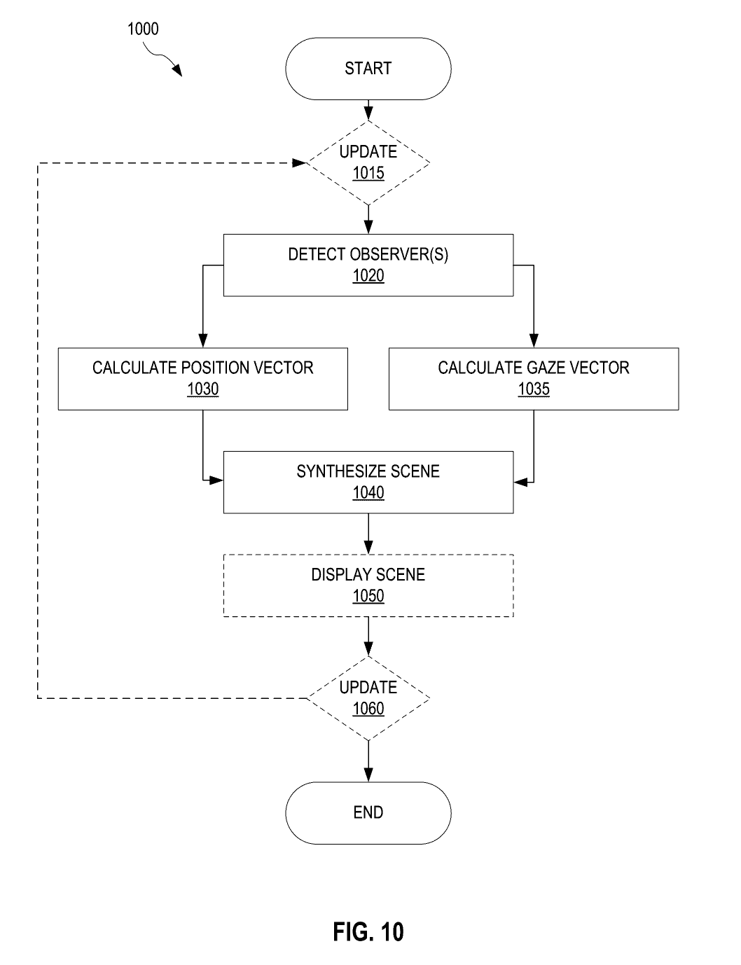

Although not explicitly shown in FIG. 1, system 100 may include one or more computer systems to perform at least a portion of the functionality of position sensing module 110, camera module 130, image processing module 150, and/or display 140, without departing from the scope hereof. Each of such computers may be, or include, a microprocessor, microcomputer, a minicomputer, an optical computer, a board computer, a field-programmable gate array (FPGA), a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, a scientific computer or a hybrid of any of the foregoing; or a known equivalent. At least a portion of method 700 (see FIG. 7 and associated discussion below) and/or method 1000 (see FIG. 10 and associated discussion below) may be implemented as machine-readable instructions encoded on non-transitory media within such a computer, and executed by a processor within this computer. In an embodiment, camera module 130 includes a computer (or several computers) that generates adaptive image 190, and/or a merged image including at least a portion of adaptive image 190, in real-time or essentially in real-time.

System 100 may generate a stream of adaptive images 190 or a stream of images each including at least a portion of a corresponding adaptive image 190. Thereby, system 100 may dynamically update display 140 in accordance with a possibly varying position 115 and/or gaze direction 126 of observer 106.

In one embodiment, system 100 generates adaptive image 190 from a number of video inputs from a respective plurality of camera devices 132 looking in a respective plurality of directions around vehicle 101. In an example of this embodiment, the plurality of directions provides a substantially 360-degree imagery of the environment of vehicle 101. Such 360-degree imagery may include elevation data in a range relevant to the vehicle navigation. In another embodiment, system 100 generates an adaptive image 190 including substantially 360-degree imagery based upon image capture by a single camera device 132 equipped with a fish-eye lens. In yet another embodiment, image generator 134 combines imagery from a plurality of camera devices 132, including possibly one or more fish-eye cameras, to generate adaptive image 190 showing a wide-angle view of the surroundings of vehicle 101, with an emphasis on a scene corresponding to gaze direction 126 reflected off virtual mirror surface 120. In yet another embodiment, camera module 130 and camera devices 132 are configured to produce adaptive image 190 as a three-dimensional image. In this embodiment, image generation module 140 may process images captured by camera devices 132 to produce adaptive image 190 as a three-dimensional image.

In embodiments of system 100 utilizing a fisheye lens, or other lens with significant distortion, system 100 may apply software processing of the as-captured image data to unwarp the as-captured image data to produce a natural looking adaptive image 190 for display. Such software may be implemented in image generator 134.

Optionally, display 140 is mounted behind a semi-reflective surface such that, when active display 140 is turned ON, the active pixels of display 140 contribute most of the visible image, while the surface of display 140 acts as a passive mirror when active display 140 is turned OFF.

Without departing from the scope hereof, system 100 may generate, and optionally display, adaptive image 190 based upon position 115 only, regardless of gaze direction 126. In one such example, system 100 generates, and optionally displays, adaptive image 190 based upon the detected position 115 and also based on the assumption that gaze direction 126 coincides with virtual mirror surface 120.

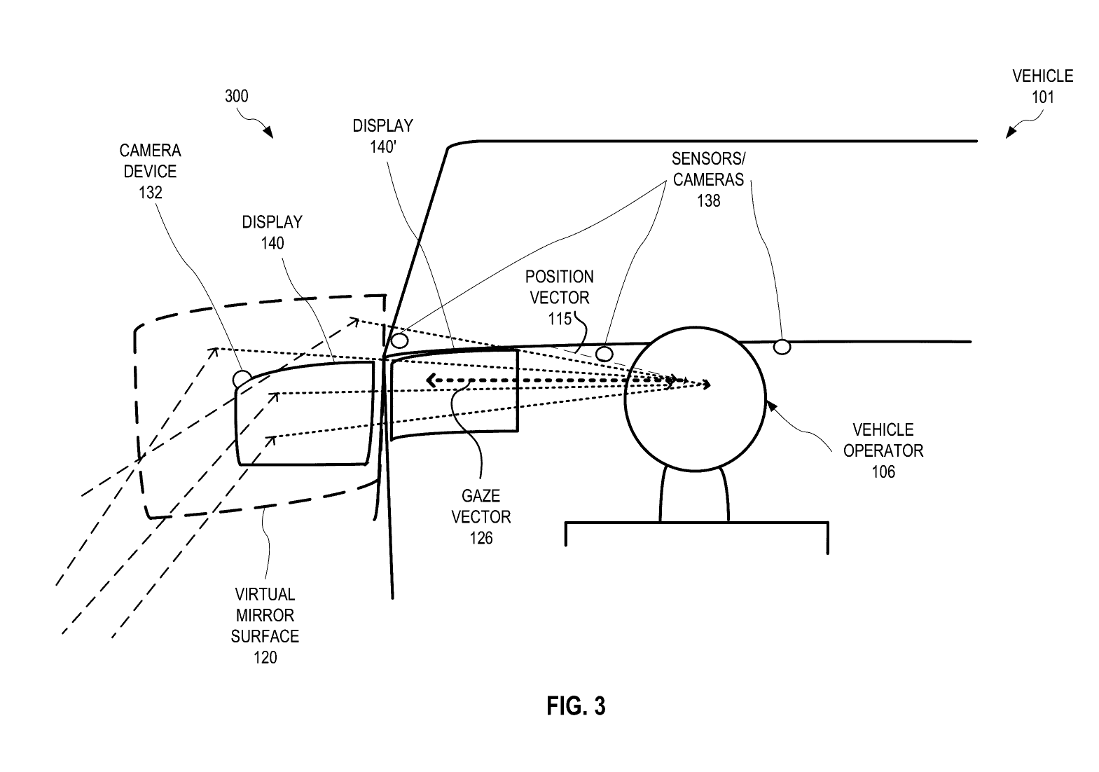

FIG. 3 illustrates one exemplary active-tracking vehicular-based system 300 that is configured with, or configured to be integrated with, two nearly contiguous displays 140 and 140′. System 300 is an embodiment of system 100. Display 140 is located on an external mirror and display 140′ is located nearby the external mirror, but interior to vehicle. The system comprises position and video sensors to determine observer position and gaze direction. It also comprises internal or external camera(s) generally providing views of the vehicle's immediate surroundings, such as rear-facing camera 136. Other camera(s) are situated elsewhere on the vehicle as necessary to substantially provide a complete view of the vehicle's immediate surroundings. Active tracking system determines the observer's position and gaze and present on active displays 140 and 140′ an image representative of the scene that the observer would have seen if an actual mirror were positioned in place of virtual mirror surface. It is noted that the virtual mirror surface may be of a position, size, and extent significantly different from that of the active display 140. In one embodiment, active display 140 is coated with a semi-reflective surface, such that when active display is turned ON then the active pixels contribute most of the visible image; while when the active display is turned OFF, the surface of display 140 acts as a passive mirror. In operation, a low-intensity light optionally illuminates the observer's face, so that position and gaze direction determination may be completed in a low external light environment, such as during nighttime vehicular operation. The active tracking system synthesizes and displays an image of variable and adaptive magnification, optionally based on both user settings and user motion with respect to the display. In one embodiment, observer's position and gaze are computed with respect to either a virtual or a physical surface (such as an active display, but not limited to that; or a windshield, etc.). The position and motion of the observer with respect to the virtual or physical surface serve as inputs to the active tracking system in determining an appropriate and variable amount of image magnification.

In an embodiment, the surface of display 140 is located within virtual mirror surface 120, while display 140′ is located externally to virtual mirror surface 120.

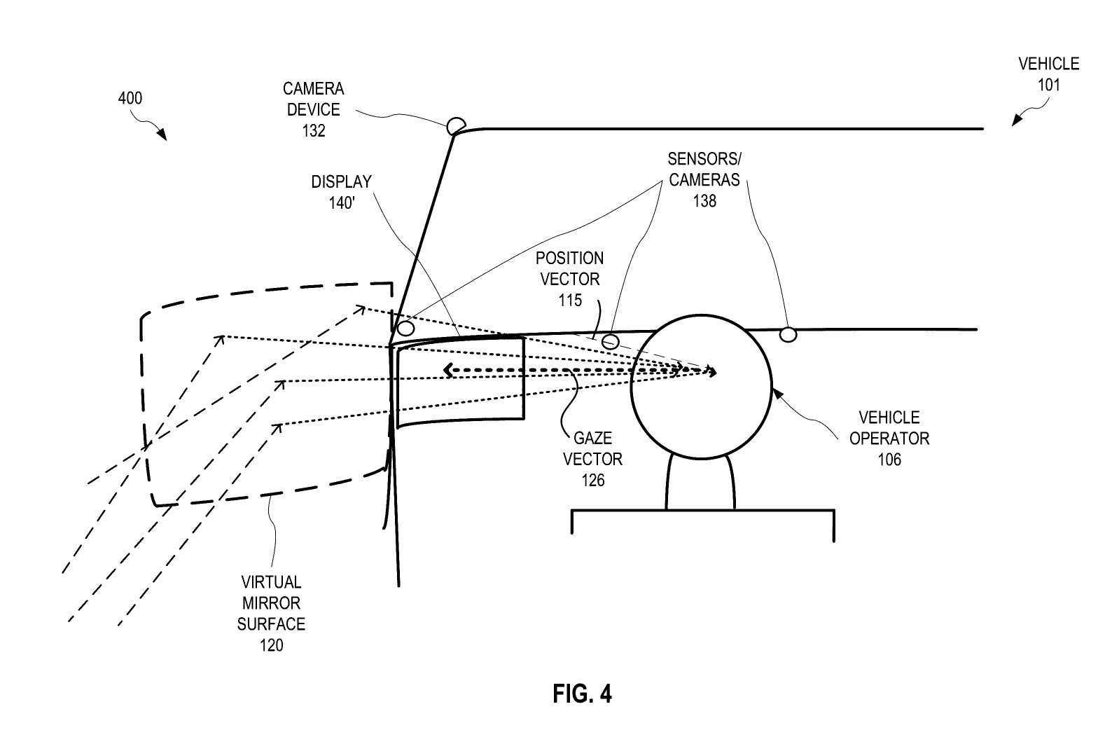

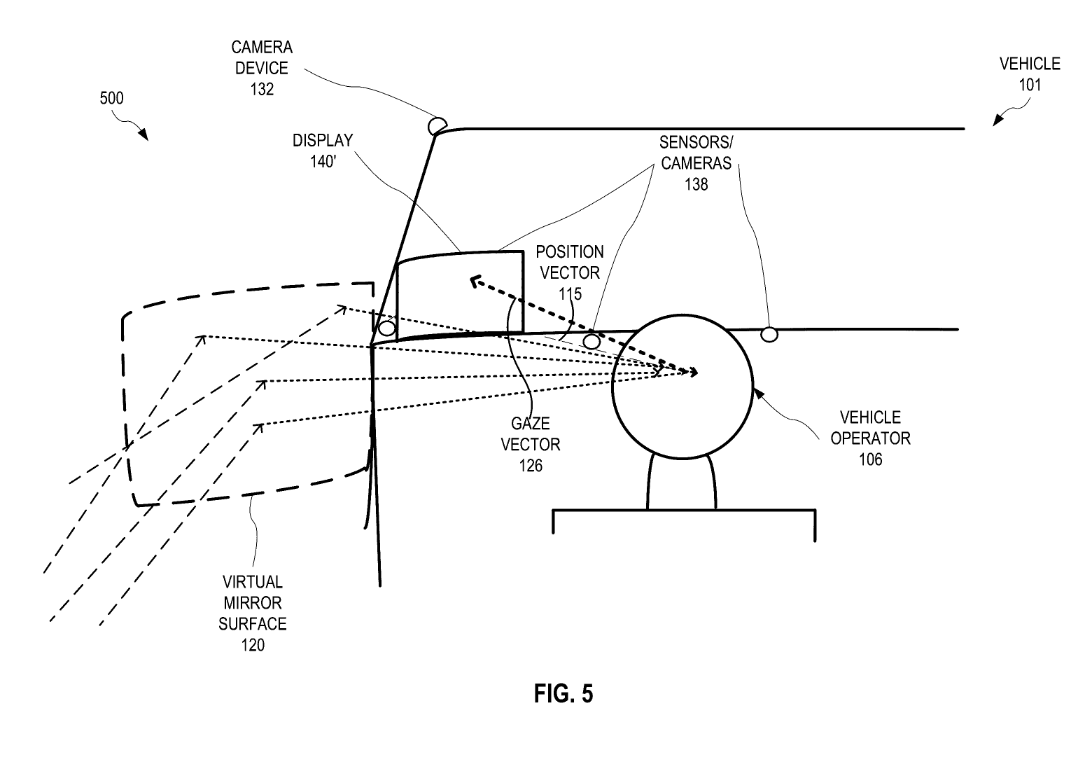

FIG. 4 illustrates one exemplary active-tracking vehicular display system 400 that is similar to system 300 except for utilizing only internal display 140′ and not external display 140. System 400 is an embodiment of system 100. Vehicle 101 may be equipped with an external passive optical mirror, such as a standard side view mirror. When system 400 determines that observer 106's gaze has crossed into a pre-defined virtual or physical surface, such as the surface of display 140′ or virtual mirror surface 120, or yet a second virtual surface separate and different from the virtual mirror surface and or the display surface, the system activates display 140′ and presents adaptive image 190 thereon. In one embodiment, adaptive image 190 corresponds to an enhanced version of what observer were to see if looking at a passive mirror of position, size, and shape corresponding with virtual mirror surface as indicated in shaded line. In the embodiment of FIG. 5, adaptive image is presented on a display that is mounted on a dashboard, either in front of the windshield or as part of the windshield. In one embodiment, windshield-mounted display is semi-transparent. The display area may be limited to the lower aspect of the windshield, or it may substantially occupy all or a significant fraction of the windshield. In one embodiment, display 140′ is semi-transparent

FIG. 5 illustrates one exemplary active-tracking vehicular-based system 400, which is an embodiment of system 400, wherein display 140′ is mounted on a windshield of vehicle 101, is a part of the windshield, or is mounted on a dashboard of vehicle 101 in front of the windshield. In one embodiment, display 140′ is semi-transparent.

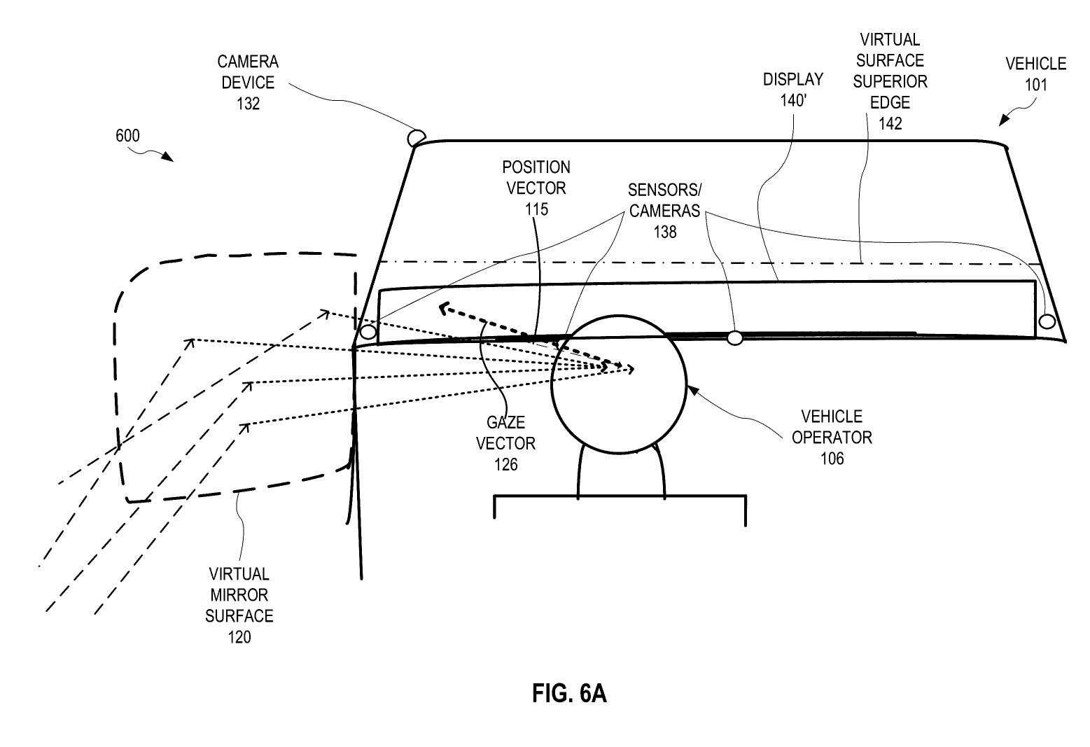

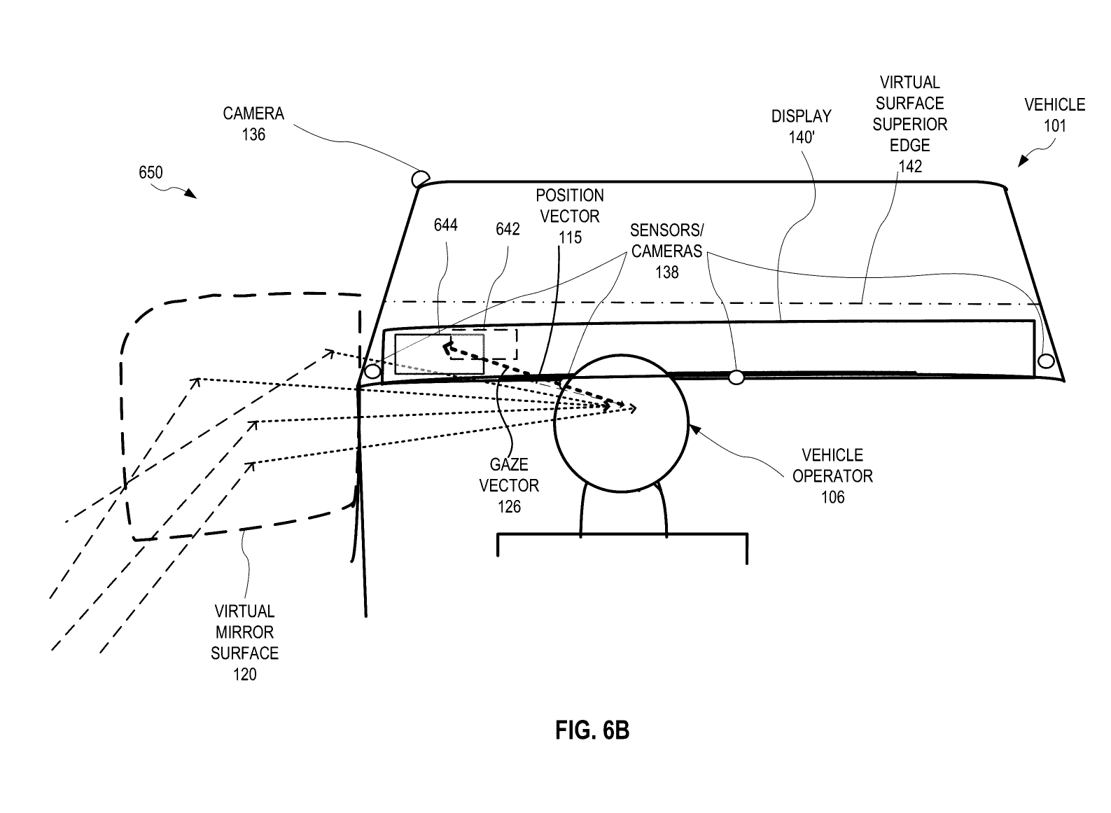

FIG. 6A illustrates one exemplary active-tracking vehicular-based system 600, which is an embodiment of system 400 similar to system 500, wherein display 140′ is mounted on, or integrated with, the windshield of vehicle 101. Display 140′ is semi-transparent. Display 140′ may be limited to the lower aspect of the windshield, i.e, below a virtual surface superior edge 142. In one implementation, display 140′ substantially occupies all or a significant fraction of the portion of the windshield below virtual surface superior edge 142.

Furthermore, system 600 may generate adaptive image 190 such that adaptive image 190 also includes forward-looking image data, in such a way that observer 106 does not loose continuity of perception of the environment into which vehicle 101 is moving.

FIG. 6B illustrates one exemplary active-tracking vehicular-based system 650, which is an embodiment of system 600, wherein, as observer 106 slides his gaze away from a “mirror-area” 644, defined here as the lower left corner of the windshield and back to a view of the road ahead, an active image display area 642, showing adaptive image 190, slides along with the gaze to occupy a more central position within display 140′. In one embodiment, as adaptive image 190 slides towards the center of display 140′, adaptive image 190 also fades in intensity.

It is understood that user's gaze direction may be monitored with respect to a virtual surface, which may be separate and different from either the display surface or the virtual mirror surface. This gaze monitoring surface may be segmented into a number of areas; based on the location of the observer's gaze direction projection onto the virtual monitoring surface, a display may become active, increase in luminosity, or slide across a wider display.

Further it is understood that the active image that is synthesized and optionally displayed may have the functionality of a wide-angle mirror image, but not the associated limitations. The synthesized adaptive image may represent a general view of the vehicle surroundings, including to the back of the vehicle, the sides of the vehicle, and optionally also including elements of a forward-view, so as to provide continuity of forward-looking to the operator/observer.

Conversely, as observer 106 moves his gaze from the road ahead toward a corner corresponding to mirror-area 644 then adaptive image 190 increases in luminous intensity as active image display area 642 slides toward the corner and also, in one embodiment, increases in area.

FIG. 7 illustrates one exemplary active-tracking vehicular-based method 700 for generating, and optionally displaying, an adaptive image representing, at least in part, a scene corresponding to immediate vehicle surroundings. Method 700 is similar to method 1400 of the section entitled “Active-tracking based systems and methods for generating mirror image” (see below), except for (a) further including a step (step 712) of determining the gaze direction 126 of observer 106, and (b) basing image capture and synthesis upon image(s) captured along the reflection of gaze direction 126 off surface 120.

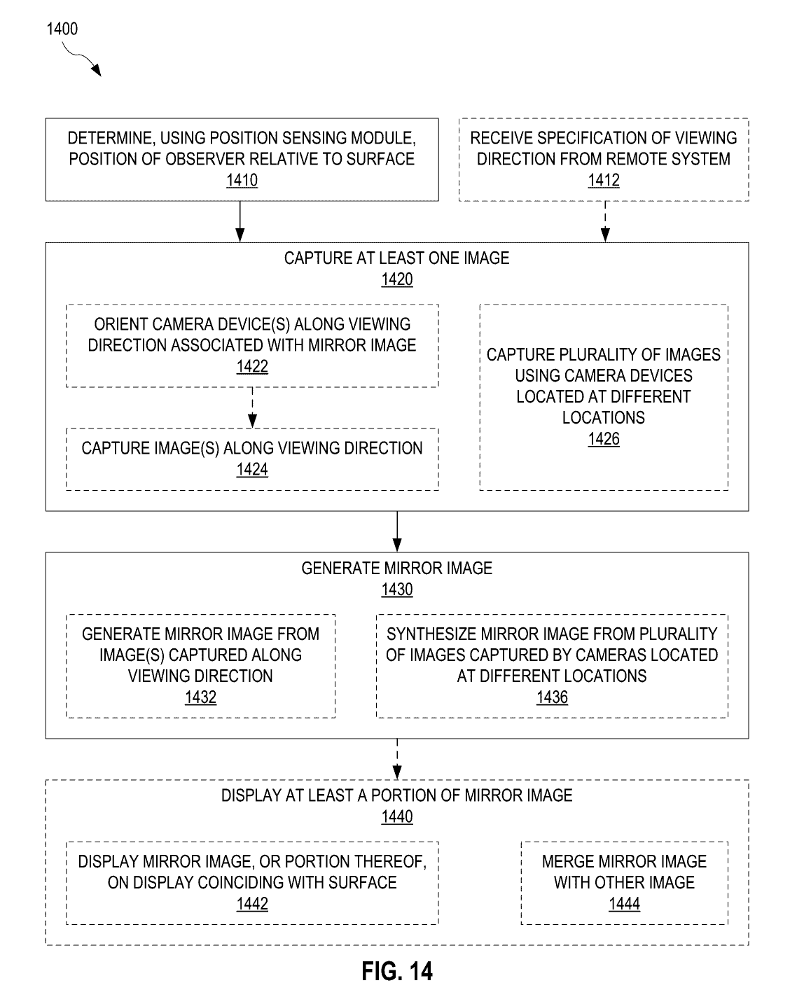

Briefly, in a step 710 of method 700, position sensing module 110 determines position 115 of observer 106 relative to surface 120 as discussed below in reference to FIG. 14 and step 1410. In step 712, gaze direction sensing module 114 determines gaze direction 126 of observer 106. In one example of step 712, gaze direction module 114 utilizes one or more sensors 116 to determine gaze direction 126 of observer 106 relative to surface 120, as discussed above. In step 720, at least one camera 132 captures at least one image of a scene according to position 106 and gaze direction 126 of observer 106 relative to surface 120, as discussed below in reference to FIG. 14 and step 1420. In step 730, one or more cameras 132 (optionally cooperating with image generation module 134) generate adaptive image 190, as discussed below in reference to FIG. 14 and step 1430. In an optional step 740, display 140 displays adaptive image 190, or at least a portion thereof, as discussed below in reference to FIG. 14 and step 1440.

In one embodiment, step 720 includes steps 722 and 724, and step 730 includes a step 732. Steps 722, 724, and 732 are similar to steps 1422, 1424, and 1432, respectively, discussed below in reference to FIG. 14. Briefly, in step 722, one or more camera devices 132 are oriented along the reflection by surface 120 of gaze direction 126. In step 724, the one or more camera devices 132 of step 722 capture one or more respective images while being in the orientation(s) set in step 722. In step 732, image generation module 140 generates adaptive image 190 from the images captured in step 724. A more detailed discussion is found below in reference to FIG. 14 and steps 1422, 1424, and 1426.

In another embodiment, step 720 includes a step 726, and step 730 includes a step 736. Step 726 uses a plurality of camera devices 132 to capture a respective plurality of images. In step 736, image generation module 134 synthesized adaptive image 190 from the plurality of images captured in step 726. A more detailed discussion is found below in reference to FIG. 14 and steps 1426 and 1436.

Optional step 740 may include step 742 and/or step 744. Steps 742 and 744 are similar to steps 1442 and 1444, respectively. In step 742, display 140 displays at least a portion of adaptive image 190 generated in step 730. In step 744, image processing module 150 merges at least a portion of adaptive image 190 with one or more other images and/or graphics data to produce a merged image, and display 140 displays this merged image.

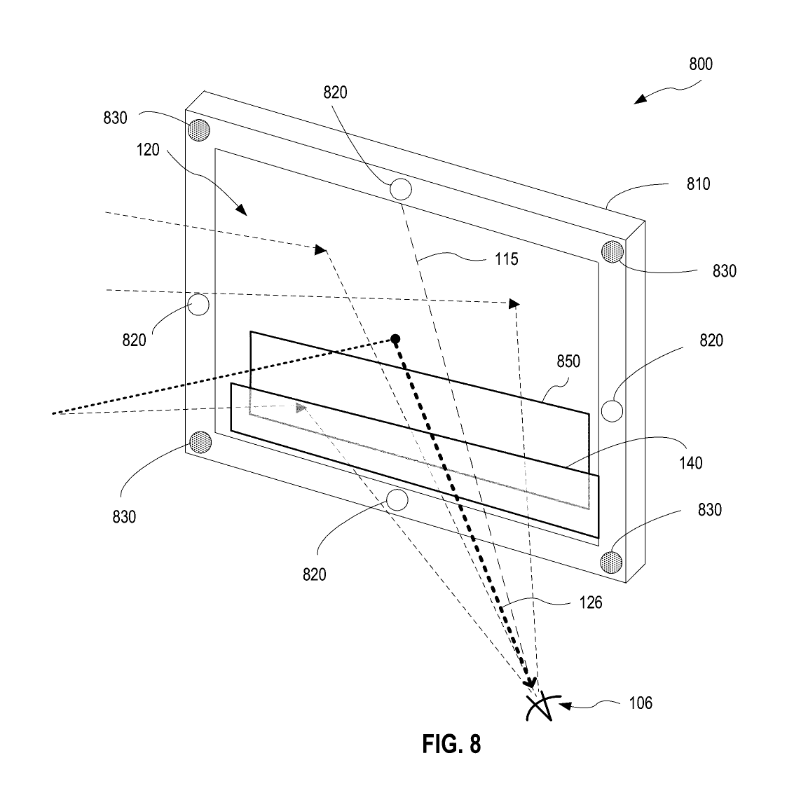

FIG. 8 illustrates one exemplary active-tracking vehicular-based system 800 integrated with a vehicular screen 810 such as a windshield, for generating and displaying adaptive image 190 on screen 810 when gaze of observer 106 intersects a virtual or physical surface 850. Adaptive image 190, displayed by system 800, may include a scene that observer 106 would have seen if observer 106 was to look at a passive optical mirror. This “virtual” passive optical mirror, e.g., surface 120, may be located away from screen 810, on screen 810, or a combination thereof.

System 800 implements at least a portion of system 100. System 800 includes position and gaze direction sensors 820, camera devices 132, and display 140. In system 800, display 140 is mounted on screen 810 or integrated with screen 810. Display 140 may be semi-transparent such that observer 106 is able to see through display 140 to observe the physical scene ahead of the vehicle. Position and gaze direction sensors 820 implement position sensors 112 and gaze direction sensors 116 and operate as discussed in reference to FIG. 1. Camera devices 830 implement camera devices 132 and operate as discussed in reference to FIG. 1. At least when gaze direction 126 intersects surface 850, sensors 820 and camera devices 830 cooperate, to generate adaptive image 190. Optionally, sensors 820 and camera devices 830 may further cooperate with other elements of system 100, such as image generator 134, to generate adaptive image 190. When gaze direction 126 intersects surface 850, system 800 displays adaptive image 190 on display 140. Display 140 may be similar to display 140′ of FIG. 6A.

Without departing from the scope hereof, the number and/or positions of both position and gaze direction sensors 820 and camera devices 132 may be different from what is shown in FIG. 8. Additionally, not all position and gaze direction sensors 820 need be identical.

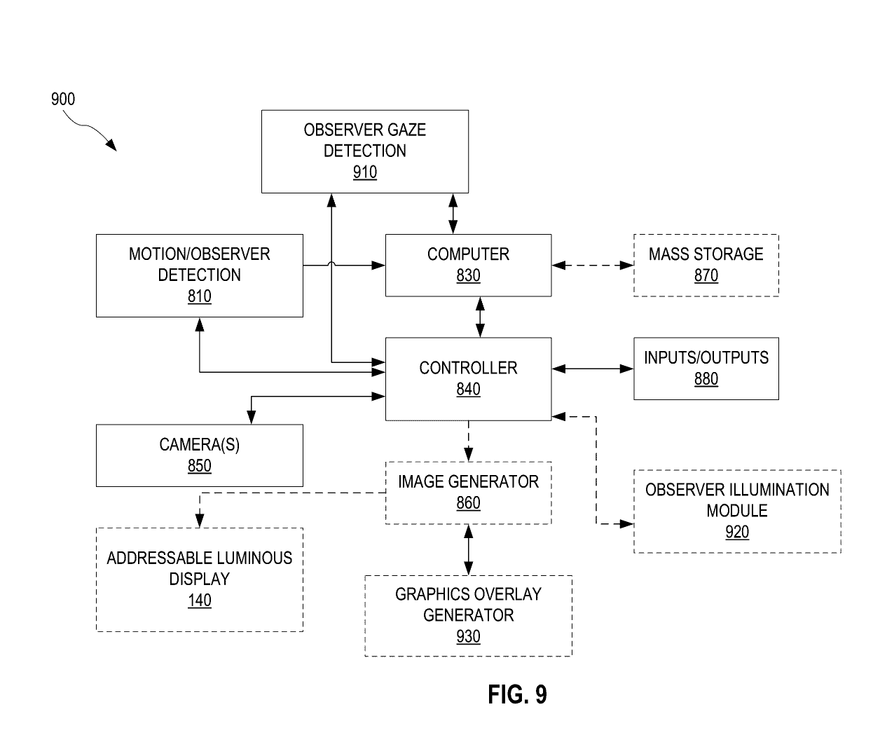

FIG. 9 illustrates one exemplary active-tracking vehicular-based system 900 for generating and displaying an adaptive image 190 that includes (a) image data pertaining to vehicle navigation and (b) a view of immediate vehicle surroundings. System 900 is an extension of system 2000 of the section entitled “Active-tracking based systems and methods for generating mirror image” (see below), extended to further include an observer gaze detection module 910, such that adaptive image 190 generated by system 900 may include an image of the scene that observer 106 would experience if observer 106 was to look at a passive optical mirror, such as a passive optical mirror located at surface 120 (see FIG. 1, for example). Additionally, as compared to system 2000 of the section entitled “Active-tracking based systems and methods for generating mirror image” (see below), system 900 further includes a graphics overlay generator 930 that overlays image data pertaining to vehicle navigation on adaptive image 190. Optionally, system 900 includes an observer illumination module 920 that illuminates observer 106 to enable gaze direction detection by observe gaze detection module 910, for example as discussed above. System 900 is one implementation of system 100.

FIG. 10 illustrates one exemplary active-tracking vehicular-based method 1000 for generating, and optionally displaying, an adaptive image 190 of the vehicle's immediate surroundings. Method 1000 is an extension of method 2200 of the section entitled “Active-tracking based systems and methods for generating mirror image” (see below), extended to further include a step 1035 of calculating a gaze vector 126 that is subsequently taken into account by step 1040 when synthesizing the scene to be displayed by adaptive image 190. Method 1000 may be performed by system 100. Steps 1015, 1030, 1040, 1050, and 1060 are similar to steps 2215, 2230, 2240, 2250, and 2260, respectively. Method 1000 may be implemented in an embodiment of method 700 including step 736. Steps 1015, 1030, and 1035 may be implemented in steps 710 and 720. Step 1040 may be implemented in step 736. Step 1050 may be implemented in step 740.

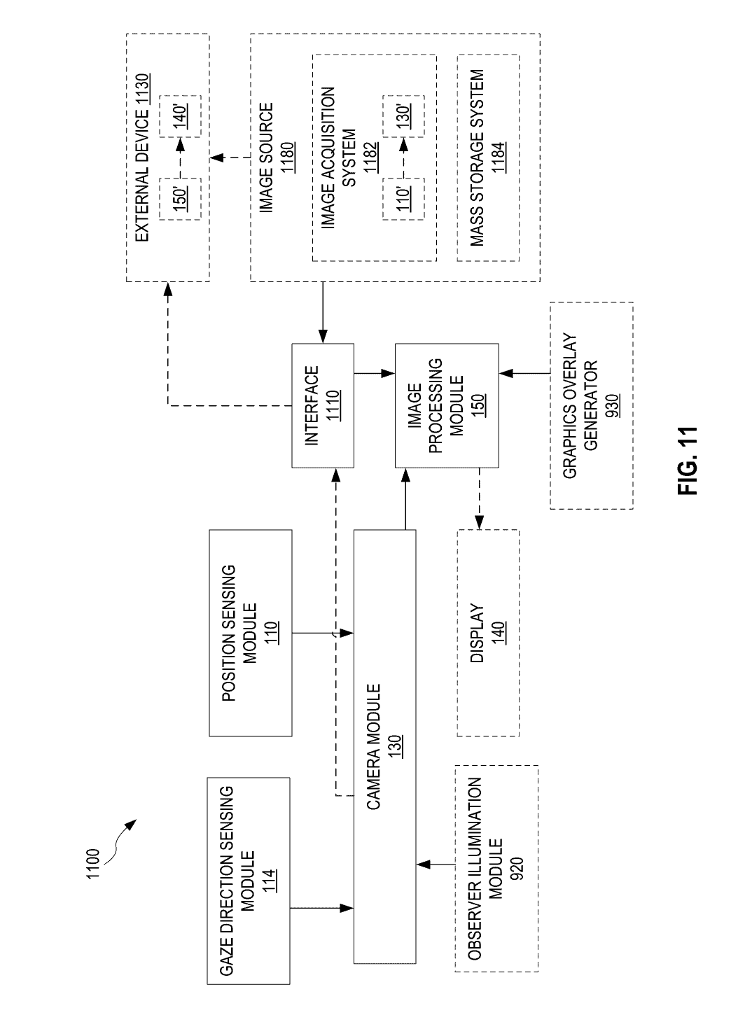

FIG. 11 illustrates one exemplary active-tracking vehicular-based system 1100, with merge and record functions, for generating and optionally displaying an adaptive image 190 that includes (a) a view of immediate vehicle surroundings such as would be provided by a mirror and (b) forward view imagery. System 1100 is an extension of system 2300 of the section entitled “Active-tracking based systems and methods for generating mirror image” (see below), extended to include gaze direction sensing module 114 and take into account gaze direction 126 when generating adaptive image 190. In system 1100, image source 1180 provides forward view imagery. System 1100 is an embodiment of system 100 and may advantageously be implemented with display 140 located on or in front of the windshield of the vehicle, for example as shown in FIGS. 5, 6A, 6B, and 8. System 1100 may utilize method 2600 of the section entitled “Active-tracking based systems and methods for generating mirror image” (see below) to generate adaptive image 190.

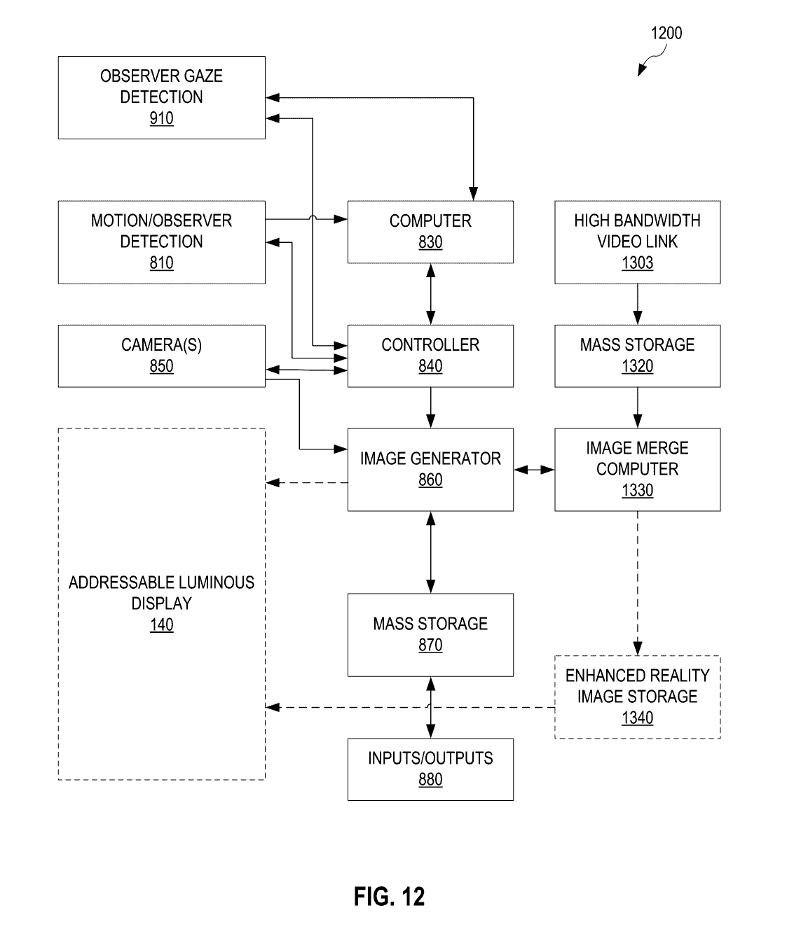

FIG. 12 illustrates another exemplary active-tracking vehicular-based system 1200, with merge and record functions, for generating and optionally displaying an adaptive image 190 that includes (a) a view of immediate vehicle surroundings such as would be provided by a mirror and (b) forward view imagery. System 1100 is an extension of system 2500 of the section entitled “Active-tracking based systems and methods for generating mirror image” (see below), extended to include observer gaze detection module 910 and take into account gaze direction 126 when generating adaptive image 190. In system 1200, high bandwidth video link 1303 provides forward view imagery. System 1100 is an embodiment of system 100 and may advantageously be implemented with display 140 located on or in front of the windshield of the vehicle, for example as shown in FIGS. 5, 6A, 6B, and 8. System 1200 may utilize method 2600 of the section entitled “Active-tracking based systems and methods for generating mirror image” (see below) to generate adaptive image 190.

Active-tracking vehicular-based system 100, and associated methods disclosed herein, may generate an adaptive image 190 that includes three-dimensional imagery. In one embodiment, for example implemented by either one of systems 500, 600, 650, 800, 1100, and 1200, such three-dimensional imagery includes a three-dimensional rendition of the road ahead. Display systems capable of representing three-dimensional information are known in the art, as are systems for generating three-dimensional information based upon image capture by a plurality of camera devices.

Corresponding reference numerals indicate corresponding parts throughout the several views of the drawings.

An embodiment of the present invention may be obtained in the form of computer-implemented processes and apparatuses for practicing those processes. The present invention may also be embodied in the form of a computer program product having computer program code containing instructions embodied in tangible media, such as floppy diskettes, CD-ROM, hard drives, digital video disks, USB (universal serial bus) drives, or any other computer readable storage medium, such as random access memory (RAM), read only memory (ROM), or erasable programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic waves and radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to generate a two-dimensional image representative of what an observer would see were the display surface to be replaced by an optical mirror of known shape and orientation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of terms first, second, etc. do not denote any order of importance, but rather the terms first, second, etc. are used to distinguish one element from another. Furthermore, the use of terms a, an, etc. do not denote a limitation of quantity, but rather denote the presence of at least one of the referenced item.

Active-Tracking Based Systems and Methods for Generating Mirror Image

Active-tracking based systems and methods may be used to generate a mirror image in a variety of applications. The following discusses active-tracking based systems and methods that do not need to be vehicular.

Television displays, computer and cell-phone screens are widely available in modern society. Large area television screens and computer displays have become available at such a low price that they commonly figure in several rooms of a modern society typical family or personal residence.

When not in use to present a television program, computer output, or other moving scene recorded on a medium such as digital video disc (DVD), video tape, or solid-state memory, such screen typically presents a dark aspect. This dark or otherwise blend aspect is in vivid contrast to the life-like images that modern displays are capable of generating and presenting. The life-like characteristics include very high spatial resolution, high dynamic range, capability of representing fine contrast of colors and shades of gray, high frame rates, high temporal resolution, large color palette, and luminous brilliance. “Screen savers” that loop through a pre-selected or random sequence of images break the monotony.

Programmable computers and similar devices have also become widely available at low cost, and are omnipresent in modern society.

Optical cameras and associated digital sensors have followed the electronics technology evolution curves and have become widely available in small formats; such as optical cameras and electronic solid-state image sensors commonly available at low cost for vehicular applications, for example. Such devices may integrate an optical lens or combination of lenses with for exemplary illustration a charge-coupled device (CCD) or complementary-metal-oxide-semiconductors (CMOS) chip that allows image formation and digital recording in a compact format. CMOS imagers are compatible with mainstream silicon chip technology and, since transistors are made by this technology, on-chip processing is possible (see for example G. C. Holst, “CCD Arrays, Cameras, and Displays”, Second edition, SPIE Optical Engineering Press, 1998). Optical sensor prices have decreased so significantly that they are now found ubiquitously in personal electronic devices such as cellular telephones.

Sensors, such as infrared sensors, ultrasonic sensors, radio-frequency sensors, have become widely available at low cost, and enable the detection of a moving object in the vicinity of the sensor(s). Such sensors are now in widespread use in automobiles, as warning systems indicative of the presence of an object, animal, or human being in the proximity to the car; as for example in use on rear vehicle bumpers to alert the driver and or automobile computer of the presence of an obstacle directly in or in the relative proximity of the moving vehicle. Other applications, such as perimeter security, have been known and practiced for years. Recently, interactive electronic systems, such as Microsoft Kinect, have been introduced that rely on the substantially instantaneous detection of a user's presence, location, and body motion and gestures.

Image processing, including processing of image sequences, has made significant advances since the time of the earliest analog recording devices. Most imaging nowadays is either recorded directly by a digital (pixelated) recording device, or a digital version is made available to the user after initial analog capture. Digital image processing includes techniques for noise reduction; contrast enhancement; coding and compression; rendition and display; and other techniques as known in the art.

Image merging is a term used herein to describe the process by which two input images are processed to generate a third image which contains information or features extracted from both input images. Examples known in the art include image fusion, wherein images of the same patient anatomy acquired by two different imaging modalities, such as computed tomography (CT) and magnetic resonance imaging (MRI), are combined to generate a merged image containing information from both associated CT and MRI input cross-section images. A method to merge or fuse two images of the same patient anatomy obtained by two different modalities is based on the mutual information measure. Another example from the medical imaging field is found in longitudinal studies, where the same anatomy of the same patient is imaged at time intervals; and new information is found (and displayed) by analyzing image changes from one acquisition to the other. This later technique is used in lung cancer screening and monitoring of lung nodules, for example. As yet another example, in aerial surveillance, pictures of a scene acquired at different wavelength (such as visible and infrared, respectively) are merged or fused to present one coherent scene where the relevant information is emphasized for the visual human observer, or for subsequent computer image analysis. Synthetic aperture radar is another common application where a final image is synthesized from a plurality of image data acquisition, as known in the art.

Image synthesis, whereby in one application a single image is generated from a multiplicity of input image sensors, is a field that has seen much recent development. Stitching, optical axis correction, merging, and other techniques as known in the art enable the generation of a single image from a plurality of sensors, the synthesized image appearing to the observer as if it had been acquired seamlessly by a single “wide-angle” camera—yet without the image distortions commonly associated with early “fish-eye” cameras. An example of an application is in vehicular technology, where a scene representing what the driver would see if he were to turn around and look back is synthesized from a multiplicity of sensors and shown on a display mounted on the vehicle dashboard.

Augmented reality is a live direct or indirect view of a physical, real-world environment whose elements are augmented (or supplemented by computer-generated sensory input such as sound, video, graphics, or GPS data). It is related to a more general concept called mediated reality, in which a view of reality is modified by a computer. As a result, the technology functions by enhancing one's current perception of reality. By contrast, virtual reality replaces the real world with a simulated one.

Virtual reality provides a computer-generated environment that aims at simulating physical presence in either a local environment or a simulated environment. Virtual reality includes remote communication and the providing of a virtual presence to the users of remote communication device, via tele-presence and tele-existence. The simulated environment may aim to emulate the real world to create a life-like experience, or may generate an artificial world for the purpose of entertainment or the communication of an environment likely to generate specific experiences in the user.

Telecommunication devices have evolved through improved bandwidth and end-user technologies such as sound, displays, three-dimensional displays that emulate an enhanced perception of depth of field, and integrated haptic devices and other sensory inputs. There exist a number of technologies that aim at achieving an improved experience of depth in an observer of a display. Exemplary applications of these technologies include figure stereoscopes, time-multiplexing displays, polarized presentation displays, specular displays for autostereoscopy (parallax stereograms), integral photography, slice-stacking displays, holographic imaging and holographic stereograms. This field is rapidly evolving, and it is expected that improved means of visualizing three-dimensional scenes will soon be commercially available.

In an embodiment, an active-tracking based system for generating a mirror image includes a position sensing module for determining the position of an observer relative to a surface. The active-tracking based system further includes a camera module for generating the mirror image based upon the position determined by the position sensing module, as the mirror image would have been experienced by the observer if the surface had been a mirror.

In an embodiment, an active-tracking based method for generating a mirror image includes determining the position of an observer relative to a surface. The active-tracking based method further includes capturing at least one image and generating, from the at least one image, the mirror image as the mirror image would have been experienced by the observer if the surface had been a mirror.

In one embodiment, a method of generating an image for presentation on an addressable display is provided. The method includes sensing the relative orientation of an observer with respect to the display, and generating an image from one or more optical sensor(s) to mimic the operation of a mirror. The method generates a synthetic image in response to input optical camera(s) and relative observer positions and orientations. The synthetic image is presented on the addressable display. From the point of view of the observer, the synthetic image is representative of a scene that would be presented were the addressable display be replaced by a passive optical mirror; or a synthetic image representative of a scene that would be presented to the observer by a passive optical mirror of known shape and of known location with respect to the active display.

Alternatively or in addition, the synthesized image may be processed by computer means in any of a variety of ways to present to the observer an enhanced image as compared to that a passive mirror would provide. For example, the displayed image may have been digitally processed to enhance resolution; to increase luminosity of selected features; or to automatically segment and present specific image features.

In another embodiment, a display system comprising an addressable luminous display, a computer, at least one position sensor, and at least one optical camera or sensor is provided. The system determines the relative orientation of an observer with respect to the display surface and generates an image from the collection of input optical camera(s), such that an image a presented to the observer that is similar to the image that would be created were the display surface be a mirror. The generated image is synthesized by a computer from input optical cameras and input observer relative position with respect to display surface. This is achievable either by controlling and orienting one or a plurality of optical sensor as a function of the observer's position with respect to the display; or by acquiring one or a plurality of images from one or a plurality of fixed or controllable image sensors, and synthesizing one image for display from the plurality of acquired images as a function of the estimated observer's position and the known positions of the various optical sensors.

In another embodiment, a display system comprising an addressable luminous display, a computer, at least one position sensor, and at least one optical device or camera is provided. The system determines the relative orientation of an observer with respect to the display surface and generates an image from the collection of input optical camera(s), such that an image a presented to the observer that is similar to the image that would be created and presented to the observer by a passive optical mirror of known shape and of known location and position with respect to the active display (and therefore, with respect to the observer). The generated image is synthesized by a computer from input optical cameras and determined observer relative position with respect to display surface.

Further, an active tracking and mirror display such as disclosed in the present invention, enables the combination of various image streams; such that the “active mirror” image synthesized by the system in response to the detection, characterization, and location determination of an observer, may be combined with other image streams: such as for example image sequences obtained from a data base; or in another example, an image sequence remotely acquired and transmitted substantially in real time to the active tracking and mirror display system. In such a way, a “virtual reality” image sequence is presented to the observer that accounts for the observer position with respect to the display, and merges or synthesizes an associated “mirror image” with an image stream either previously recorded or recorded somewhere else and transmitted substantially in real-time to the active display system. In such an embodiment, feature(s) from one input image stream (say, for illustration, the pre-recorded or remotely acquired image stream) are extracted and merged with the input image stream generated by the active tracking part of the system; in such a way that a virtual-reality type image sequence is generated for presentation to the system observer/viewer. As an illustration, the face and or body of a person may be extracted from the pre-recorded or remotely acquired image sequence/stream, and merged into the active mirror generated image sequence/stream; so that the system observer/viewer sees that person's face and or body as if it were in reality seen through a mirror: the remote person appears immersed into the local observer environment, merged within the image field provided by the active tracking and mirror display itself. Thus the system and methods of the present invention provide a virtual reality representation of a remote video conference/meeting participant.

In yet another embodiment, a computer readable medium is provided. The medium is encoded with a program configured to instruct a computer to generate a synthetic image from at least one optical camera and from an input direction representative of the relative position of an observer with respect to the display surface. In one embodiment, the computer also records the synthetic image or image sequence generated by the active tracking and mirror display. In another embodiment, the computer also records a synthetic image or image sequence generated by merging the active tracking and mirror image generated by the system with another image either previously recorded or remotely acquired. The recording thus enables later virtual-reality rendition by merging the recorded video stream with a second video stream; the second video stream being either synthesized by the system as described above, obtained from a second recording, or remotely acquired and transmitted to the system.

In another embodiment, the present invention relates to the field of telecommunications. Two or more remote users each utilizing a system per the present invention could communicate in essentially real-time with an enhanced remote presence being achieved by the method and devices described below. Each user benefiting from a virtual reality representation of the remote user in his/her local environment.

Additionally, the present invention also relates to the generation and display of three-dimensional information, as a means to further improve upon the quality of the life-like experiences made possible through the devices and methods outlined herein.

Disclosed below are active-tracking based systems and methods that generate, and optionally display, a mirror image or mirror image sequence representing a scene that appears, to an observer, to be that reflected by a passive optical mirror. The active-tracking based systems and methods determine the position of the observer to generate the mirror image or mirror image sequence, and may produce life-like imagery for a display, such as a large area television screens and computer displays.

The presently disclosed active-tracking based systems and methods provide a mode of operation of an active, addressable display, such that the display presents to the observer a scene similar to that provided by an optical mirror, whether the mirror is flat or not. Such a display mode allows yet another use for the display, in essence that of an optical mirror (or “passive display”).

In one example, the active-tracking based systems and methods disclosed herein produce an image that presents, to an observer, the mirror image that the observer would have experienced if the display had been a passive optical mirror. In another example, these active-tracking based systems and methods produce an image that presents, to an observer, the mirror image that the observer would have experienced if the display had been replaced by a passive optical mirror of known shape and location with respect to the display.

Also disclosed herein are active-tracking based systems and methods that generate a mirror image, or mirror image sequence, representing a scene that appears, to an observer, to be that reflected by a passive optical mirror, and merge such a mirror image with a second image or image sequence. In one implementation, such active-tracking based systems and methods are used to generate an augmented reality or virtual reality experience, whereby an image or rendition of a scene is generated or synthesized from a multiplicity of image and other inputs, to create in an observer the illusion or semblance that the displayed scene is real. In another implementation, two such active-tracking based systems are used to perform improved remote video communication between two users to generate an augmented reality or virtual reality experience, whereby an image or rendition of a scene is generated or synthesized from a multiplicity of image and other inputs, to create in an observer the illusion or semblance that the displayed scene is real.

In certain embodiments, the active-tracking based systems and methods discussed above generate, and optionally display, three-dimensional images. Such embodiments may generate and render a three-dimensional model of an observer or, in the case of remote video communication, two observers.

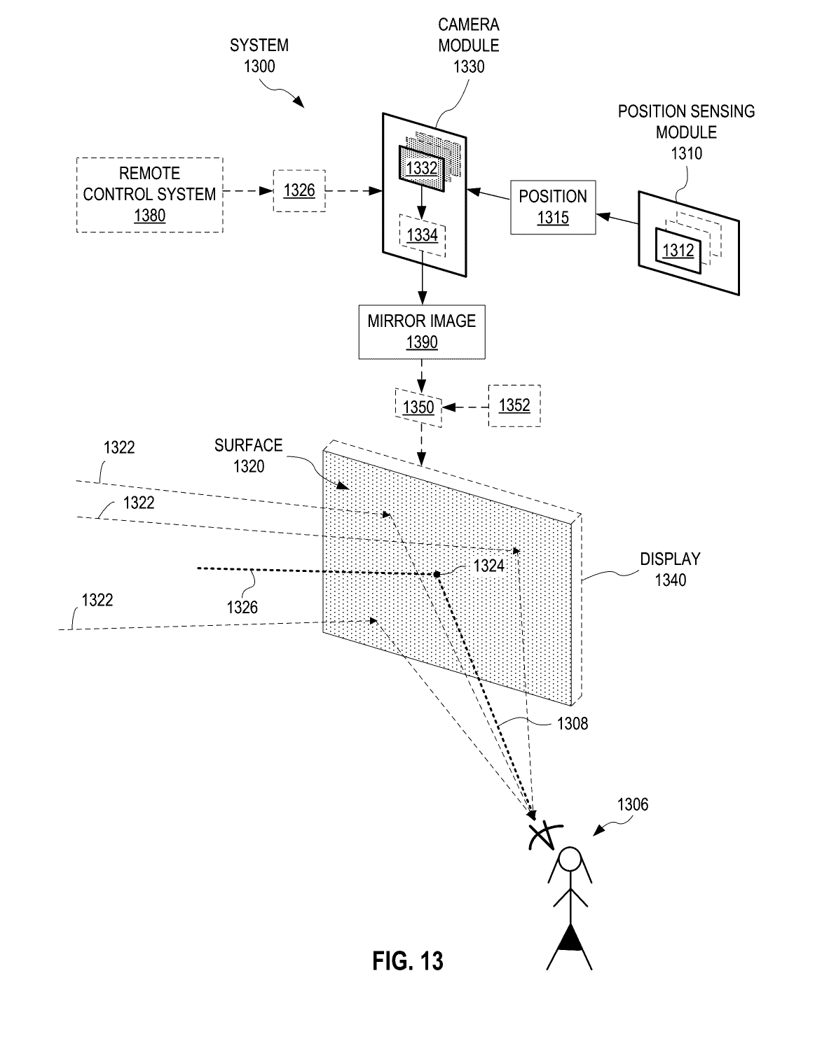

FIG. 13 illustrates one exemplary active-tracking based system 1300 for generating, and optionally displaying, a mirror image 1390 representing a scene that appears, to an observer 1306, to be that reflected by a passive optical mirror located at a surface 1320.

Surface 1320 may be a physical surface, such as the surface of an addressable luminous display 1340, or a virtual surface. Although shown in FIG. 13 as coinciding with display 1340, surface 1320 may be, at least in part, different from the surface of display 1340, without departing from the scope hereof. Additionally, surface 1320 may have shape differently from that shown in FIG. 13 and/or be curved. Additionally, surface 1320 may include two or more separate surfaces, each of known position and orientation. Surface 1320 may represent all of the surface of display 1340, a sub-portion of the surface of display 1340, or several sub-portions of the surface of display 1340. Display 1340 is not necessarily considered flat, or rectangular. Display 1340 may be comprised of several surfaces, each of known position and orientation.

FIG. 14 illustrates one exemplary active-tracking based method 1400 for generating, and optionally displaying, mirror image 1390 (FIG. 13). FIGS. 13 and 14 are best viewed together.

Active-tracking based system 1300 includes a position sensing module 1310 and a camera module 1330. Position sensing module 1310 determines the position 1315 of observer 1306 relative to surface 1320. Position sensing module 1310 includes one or more position sensors 1312 that cooperate to sense observer 1306 and determine the position of observer 1306 relative to surface 1320. Camera module 1330 includes at least one camera device 1332 configured to capture an image. Each camera device 1332 may include an optical lens and a digital image sensor. Camera module 1330 may further include an image generator 1334 that processes one or more images captured by camera device(s) 1332 to generate an output image. Camera module 1330 is communicatively coupled with position sensing module 1310. Optionally, active-tracking based system 1300 further includes one or both of display 1340 and an image processing module 1350.

In a step 1410 of method 1400, position sensing module 1310 determines position 1315 of observer 1306 relative to surface 1320. In one example, position sensing module 1310 determines a position vector 1308 that indicates position 1315 with respect to a coordinate system of surface 1320 having origin 1324. Origin 1324 is the center of surface 1320, for example. Position vector 1308 may indicate (a) the direction in which observer 1306 is located relative to surface 1320, and the distance between surface 1320 and observer 1306, or (b) only the direction in which observer 1306 is located relative to surface 1320. Position vector 1308 may represent an estimate of the location of observer 1306.

Position sensor(s) 1312 may use visible light, infrared light, or other electromagnetic radiation to determine the presence of an observer 1306. Detected electromagnetic radiation maybe either reflected by surfaces of observer 1306 (such as clothing or skin), or emitted by observer 1306, as known from Planck's law of black-body radiation. Alternatively or in combination, position sensor(s) 1312 may use sound or ultrasound information to determine the position of observer 1306. In one exemplary scenario, observer 1306 is a human observer. Position sensor(s) 1312 may determine position 1315 through various sensing methods as known in the art, such as used in remote sensing applications (radar or sonar, for example). Position sensor(s) 1312 may also use other technology, such as ultrasound sensing or pressure sensing, or a combination thereof. In one embodiment, position sensor(s) 1312 reacts in response to an element worn by observer 1306, such as an electromagnetic emitter, or electromagnetic reflector. In another embodiment, position sensor(s) 1312 does not require the observer to wear any device specific element. It is noted that position sensor(s) 1312 may include optical camera(s) and computer means to automatically extract image features, such as an observer's face and eyes, to determine said observer location in relation to surface 1320. Such computations may include automated image analysis techniques such as image segmentation, pattern recognition, feature extraction and classification, and the like, as is known in the art. Position sensor 1312 may be a motion detector.

In one example, a single position sensor 1312, or each of a plurality of position sensors 1312, generate sufficient data that position sensing module 1310 may determine the position of observer 1306 therefrom. In another example, each of a plurality of position sensors 1312 provide incomplete position information for observer 1306, which is cooperatively processed by position sensing module 1310 to determine the position of observer 1306.

There may be more than one observer 1306, in which case position sensing module 1310 may (a) generate mirror image 1390 based upon position vector 1308 to the closest observer 1306, (b) generate mirror image 1390 based upon an average or weighted average of position vectors 1308 associated with the multiple observers 1306, or (c) generate mirror image 1390 based upon user input specifying a single observer 1306 for which mirror image 1390 should be generated. In the “Active-tracking based systems and methods for generating mirror image” section of this disclosure, it is understood that observer 1306 may refer to a plurality of observers 1306 and that active-tracking based systems and methods disclosed in the “Active-tracking based systems and methods for generating mirror image” section may be configured to handle multiple observers 1306 as discussed above, for example.

In a step 1420 of method 1400, camera module 1330 uses camera device(s) 1332 to capture at least one image. In a step 1430 of method 1400, camera module 1330 generates mirror image 1390 based upon the image or images captured in step 1420. Camera module 1330 may output, as mirror image 1390, an image captured in step 1420, or camera module 1330 may utilize image generator 1334 to process one or more images captured in step 1420 to generate mirror image 1390 therefrom.

In one embodiment, camera module 1330 includes a single camera device 1332 and mirror image 1390 corresponds to the image captured by this single camera device.

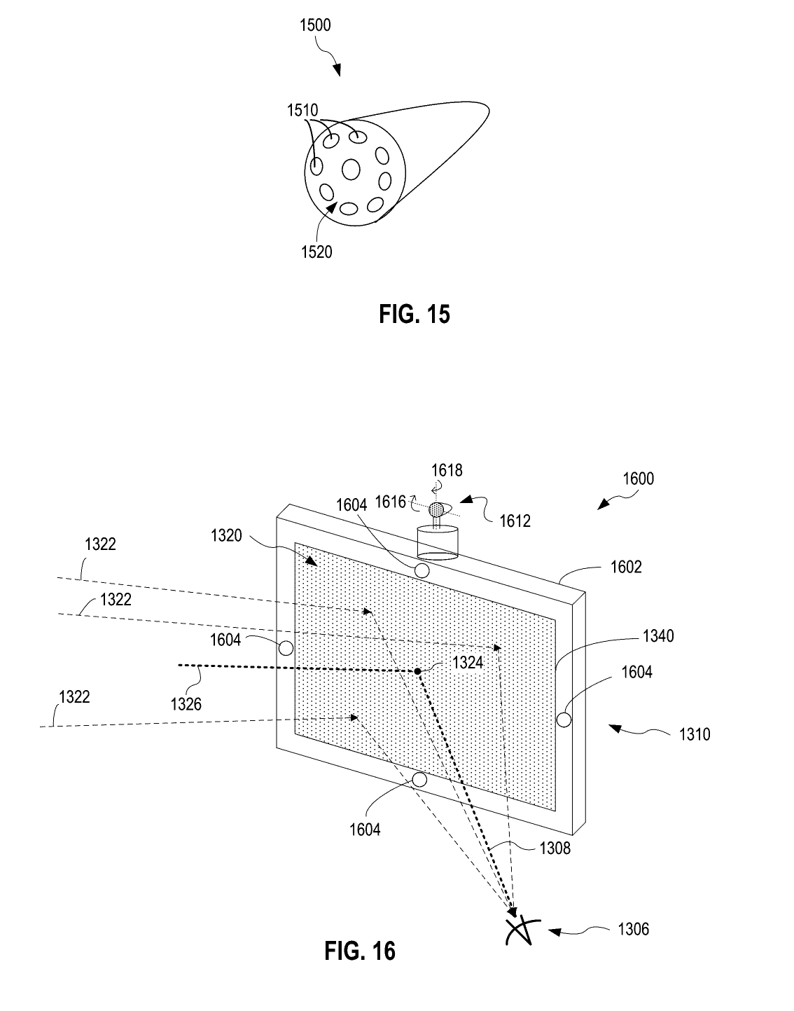

In another embodiment, camera module 1330 includes a plurality of camera devices 1332, each oriented at a different angle, for example as shown in FIG. 15, discussed below.

In yet another embodiment, camera module 1330 includes one or more light-field optical cameras (also known as a plenoptic camera), each implementing a camera device 1332. A light-field optical camera uses a micro-lens array to collect “four-dimensional” light field information about a scene, which enables the generation of several images from a single captured image. Such acquisition technology is helpful in a number of computer vision applications, and allows the acquisition of images that may be refocused after they are taken, as well as permitting a slight change in view angle after acquisition.

In one embodiment, step 1420 implements sequential steps 1422 and 1424, and step 1430 implements a step 1432. This embodiment of method 1400 utilizes an embodiment of camera module 1330, which includes at least one camera device 1332 that has flexible orientation.

In step 1422, camera module 1330 receives position 1315. Based upon position 1315, camera module 1330 orients at least one camera device 1332 along a viewing direction 1326 associated with mirror image 1390 on surface 1320. For example, camera module 1330 orients at least one camera device 1332 such that the optical axis of each camera device 1332 is parallel to viewing direction 1326. Viewing direction 1326 is the reflection, off surface 1320 or an extension thereof, of the direction of observer 1306's view of surface 1320. It is noted that surface 1320 is a distributed surface, and the actual viewing direction may vary across surface 1320. At origin 1324, the viewing direction is the reflection of position vector 1308 off surface 1320. Viewing direction 1326 may refer to a direction that is generally consistent with viewing directions across surface 1320, given position 1315 of observer 1306. Viewing direction 1326 may be the average viewing direction across surface 1320. Alternatively, viewing direction 1326 may depend on the location of camera device 1332 and be a reflection of the vector from observer 1306 to camera device 1332 off a plane that is defined by surface 1320, or an extension thereof, at the location of camera device 1332. In one example of step 1422, camera module 1330 orients a single camera device 1332 along viewing direction 1326. In another example of step 1422, camera module 1330 orients a plurality of camera devices 1332 along a plurality of viewing directions that may be identical or slightly differ based upon the location of respective camera devices 1332. In step 1424, each camera device 1332 used in step 1422 captures an image along the associated viewing direction.

In step 1432, camera module 1330 generates mirror image 1390 from the image or images captured in step 1424 along viewing direction 1326. In one example of step 1432, camera module 1330 outputs an image, captured in step 1424, as mirror image 1390. In another example of step 1432, image generator 1334 processes a plurality of images captured in step 1424 to generate mirror image 1390 therefrom. Image generator 1334 may utilize such a plurality of images to (a) synthesize mirror image 1390 to produce a mirror image representative of that generated by a distributed surface, such as a passive mirror surface, (b) achieve a wider field of view than that provided by any individual camera device 1332, and/or (c) generate a three-dimensional mirror image 1390.

In another embodiment, step 1420 implements a step 1426 and step 1430 implements a step 1436. This embodiment of method 1400, utilizes an embodiment of camera module 1330, which includes a plurality of camera devices 1332 that have fixed orientation and are located at a plurality of different locations. In step 1426, the plurality of camera devices 1332 captures a plurality of images. In step 1436, image generator 1334 receives position 1315. Based upon position 1315, image generator 1334 processes the plurality of images, captured in step 1424, to synthesize an image along viewing direction 1326, thus generating mirror image 1390. This embodiment of method 1400 may utilize the plurality of camera devices 1332 to (a) synthesize mirror image 1390 to produce a mirror image representative of that generated by a distributed surface, such as a passive mirror surface, (b) achieve a wider field of view than that provided by any individual camera device 1332, and/or (c) generate a three-dimensional mirror image 1390. Methods to synthesize a scene from a plurality of image sequences include image fusion; image segmentation; image stitching; image generation; and related techniques as known in the art of image processing. Step 1436 may utilize one or more of such methods.

In one embodiment, synthesizing mirror image 1390 includes analyzing a video stream of images from a camera focused on the user, and determining the observer 1306's direction of gaze as an input in computing mirror image 1390 that most accurately represents what the observer would see if display 1340 were replaced by a passive mirror.

In one embodiment, mirror image 1390 may essentially correspond to an image that would be generated at observer 1306's location by a reflector or partial reflector of known surface shape, known orientation and position with respect to observer 1306, and optionally of known light reflecting, refracting, attenuating, and transmitting properties, wherein such refracting, attenuating, transmitting properties may be position-dependent on the reflective or partially reflective surface. It is noted that neither position sensing module 1310 nor camera module 1330 need to be physically integrated with display 1340 (if included). However, method 1400 utilizes, in real time, the position and orientation of position sensor(s) 1312 and camera device(s) 1332 with respect to surface 1320.

Optionally, method 1400 may further include a step 1440 of displaying at least a portion of mirror image 1390 on display 1340. In one embodiment, surface 1320 coincides with display 1340 (as shown in FIG. 13), and step 1440 implements a step 1442 of displaying at least a portion of mirror image 1390 on an associated portion of display 1340.

Display 1340 is, for example, a cathode-ray-tube (CRT), flat-panel display using liquid-crystal-display (LCD), plasma flat-panel display, light-emitting-diode (LED) displays, organic light-emitting diodes displays, projector displays, or generally any addressable display capable of presenting an image (scene) either digitally acquired or digitally sampled from an analog input.

Step 1440 may include a step 1444, wherein (a) image processing module 1350 merges mirror image 1390 with another image 1352 to produce a merged image, and (b) display 1340 displays this merged image. Without departing from the scope hereof, method 1400 may generate the merged image without displaying it.

In certain embodiments, camera module 1330 is communicatively coupled with a remote control system 1380 that specifies viewing direction 1326. In such embodiments, active-tracking based method 1400 includes a step 1412 of receiving a specification of viewing direction 1326 from remote control system 1380. This corresponds to a scenario wherein observer 1306 is a point in space having a predefined location or trajectory. In one example, remote control system 1380 communicates a viewing direction 1326 corresponding to a view of interest. In another example, remote control system 1380 communicates a series of viewing directions 1326 to perform a raster scan. This raster scan may serve to search, and optionally locate, an object of interest such as a human observer 1306. After locating this object of interest, using the raster scan, method 1400 may proceed to perform step 1410 to actively track this object of interest. Step 1412 may replace step 1410, without departing from the scope hereof. Likewise, remote control system 1380 may replace position sensing module 1310.

Neither active-tracking based system 1300 nor active-tracking based method 1400 require that observer 1306 is included in mirror image 1390. Observer 1306 may be located at any position 1315 relative to surface 1320, as long as the associated viewing direction 1326 is viewable by at least one camera device 1332.

Although not explicitly shown in FIG. 13, active-tracking based system 1300 may include one or more computer systems to perform at least a portion of the functionality of position sensing module 1310, camera module 1330, image processing module 1350, and/or display 1340, without departing from the scope hereof. This computer may be, or include, a microprocessor, microcomputer, a minicomputer, an optical computer, a board computer, a field-programmable gate array (FPGA), a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, a scientific computer or a hybrid of any of the foregoing; or a known equivalent. At least a portion of method 1400 may be implemented as machine-readable instructions encoded on non-transitory media within such a computer, and executed by a processor within this computer.

Although not shown in FIG. 14, method 1400 may repeat steps 1410, 1420, 1430, and optionally 1440 to generate a stream of mirror images 1390 or a stream of images each including at least a portion of a corresponding mirror image 1390. Thereby, method 1400 may dynamically update display 1340 in accordance with a possibly varying location of observer 1306.

FIG. 15 illustrates one exemplary “honeycomb” camera module 1500 having a plurality of camera devices 1510 arranged on a curved surface 1520 and oriented along different directions. Camera module 1500 is an embodiment of camera module 1330 (FIG. 13), and camera device 1510 is an embodiment of camera device 1332. The optical axes of camera devices 1510 diverge or converge away from curved surface 1520 toward the scene viewed by camera devices 1510. Curved surface 1520 may be a paraboloid. By virtue of the honeycomb arrangement, camera module 1500 enables correction for parallax effects. Parallax effects occur since a passive mirror processes incoming light on a distributed surface, whereas a single camera has a unique defined optical axis. Therefore, providing a multiplicity of cameras with optical axis pointing at a multiplicity of angles enables the synthesizing of an image field representative of that generated by a passive mirror surface.

In certain embodiments, active-tracking based system 1300 implements honeycomb camera module 1500 as camera module 1330. In one such embodiment, a plurality of camera devices 1510 captures a respective plurality of images in step 1426 of method 1400 (FIG. 14). In step 1436, image generator 1334 synthesizes this plurality of images to generate mirror image 1390.

FIG. 16 illustrates one exemplary active-tracking based system 1600 for generating, and optionally displaying, mirror image 1390 (FIG. 13). Active-tracking based system 1600 is an embodiment of active-tracking based system 1300 and may implement active-tracking based method 1400 (FIG. 14).

Active-tracking based system 1600 includes a display device 1602 with (a) display 1340 and (b) position sensing module 1310. In active-tracking based system 1600, position sensing module 1310 includes one or a plurality of position sensors 1604. Each position sensor 1604 is an embodiment of position sensor 1312. Each position sensor 1604 may be stationary. Active-tracking based system 1600 further includes a rotatable camera module 1612 which is an embodiment of camera module 1330. Camera module 1612 generates mirror image 1390, and display 1340 displays mirror image 1390.

Through position determination computations performed by position sensing module 1310, active-tracking based system 1600 determines the position of observer 1306 with respect to the coordinate system (including origin 1324) of display device 1602, as represented schematically by position vector 1308 (assumed to originate at the coordinate system center).

Camera module 1612 is rotatable about axes 1616 and 1618. In one example, axes 1616 and 1618 are essentially perpendicular, and combination of these two axes' rotations allows pointing camera module 1612 in a range of directions with respect to display 1340. For example, camera module 1612 may be rotated about axes 1616 and 1618 to view any direction in optical communication with the side of surface 1320 facing observer 1306. Based upon position vector 1308, active-tracking based system 1600 orients camera module 1612 and processes light collected by one or plurality of camera devices 1332 within camera module 1612 to generate or synthesize mirror image 1390. Camera module 1612 may be automatically and adaptively oriented to observe an optical scene as a function of a position vector 1308, such that the optical scene captured by camera module 1612 essentially corresponds to what observer 1306 would see were display 1340 replaced by an optical mirror. For example, camera module 1612 is oriented to be generally aligned with viewing direction 1326.

Camera module 1612 may include one or more camera devices 1332. For example, camera module 1612 may be implemented as honeycomb camera module 1500 (FIG. 15). In one embodiment, camera module 1612 includes one or more light-field optical cameras.

In certain embodiments, camera module 1512 includes a single rotatable camera device 1332, and display device 1602 includes a plurality of position sensors 1604.

Although shown in FIG. 16 as being mechanically coupled with display 1340, position sensor(s) 1604 and/or camera module 1612 may be located in known locations away from display device 1602, without departing from the scope hereof. In this case, system 1600 may include and utilize results of a calibration procedure to determine respective positions and orientation of camera module with respect to the coordinate system of display 1340. Although not shown in FIG. 16, active-tracking based system 1600 may include a computer for performing at least a portion of the functionality discussed above, as discussed in reference to FIG. 13. Without departing from the scope hereof, active-tracking based system 1600 may be implemented without display 1340. In this case, active-tracking based system 1600 generates mirror image 1390 and may communicate mirror image 1390 to a display separate from active-tracking based system 1600.

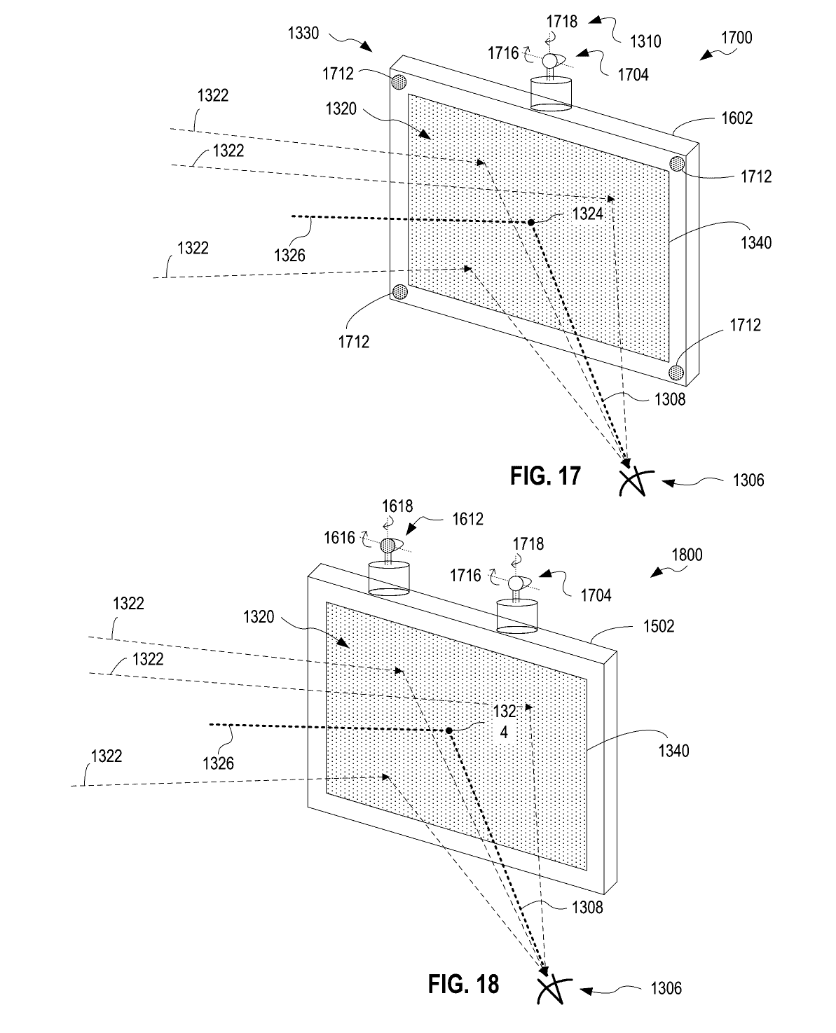

FIG. 17 illustrates one exemplary active-tracking based system 1700 for generating, and optionally displaying, mirror image 1390 (FIG. 13). Active-tracking based system 1700 is an embodiment of active-tracking based system 1300 and may implement active-tracking based method 1400 (FIG. 14). Active-tracking based system 1700 is similar to active-tracking based system 1600 (FIG. 16), except that active-tracking based system 1700 implements (a) position sensing module 1310 as rotatable position sensing module 1704 having a single position sensor, and (b) camera module 1330 with a plurality of camera devices 1712. Position sensing module 1704 is an embodiment of position sensing module 1310. Each camera device 1712 is an embodiment of camera device 1332.

Position sensing module 1704 is rotatable about axes 1716 and 1718. In one embodiment, axes 1716 and 1718 are essentially perpendicular, and combination of these two axes' rotations allows pointing position sensing module 1704 in a range of directions with respect to display device 1502. In one example, position sensing module 1704 is rotatable to detect an observer 1306 regardless of the direction in which observer 1306 is located relative to display 1340. In another example, position sensing module 1704 is rotatable to detect an observer 1306 having a line-of-sight to display 1340.

Position sensing module 1704 may be automatically and adaptively oriented to track observer 1306, and provide necessary data for calculation of position vector 1308.

Each of the multiplicity of camera device(s) 1712 may be either fixed or individually controllable and oriented in three-dimensional space with respect to display device 1602. The multiplicity of optical inputs thus allows the generation of a synthesized mirror image 1390, in step 1436, that accurately simulates the output image that would be generated and seen by the observer were display 1340 replaced by a passive optical mirror distributed over a surface of known position and orientation (or a plurality of such surfaces).

Synthesizing one view from a plurality of input views, provided by the plurality of camera devices 1712, may be achieved with well-established camera technologies. Yet, new developments in the field of plenoptic photography make refocusing and slightly adjusting the main view angle of a given image possible after recording. It is clear that such technological advances could be leveraged in the present invention, by allowing each of a plurality of plenoptic (or “light field”) cameras to be refocused after data acquisition generally per the direction and depth of field desirable given a specific observer position vector, camera position with respect to display 1340, and determined depth of field of the image to be synthesized. It may still be desirable to enable orientation control for each of these plenoptic cameras, so that only a minor correction for view direction need to be performed after image acquisition by each camera. The use of a plurality of spatially distributed optical cameras, and/or light-field cameras, enables the correction for various known optical effects such as parallax, and enables the generation of an image simulating accurately that that would be generated for a given observer of known location by a passive mirror of know shape and spatial extension. In one embodiment, this passive mirror that is being simulated is essentially of a location and spatial extend corresponding to display 1340; in another, more general embodiment, the passive mirror that is being simulated for observer 1306 may be of a different (but known) shape and location with respect to display 1340.

FIG. 18 illustrates one exemplary active-tracking based system 1800 for generating, and optionally displaying, mirror image 1390 (FIG. 13) and may implement active-tracking based method 1400 (FIG. 14). Active-tracking based system 1800 is an embodiment of active-tracking based system 1300. Active-tracking based system 1800 is similar to active-tracking based system 1600 (FIG. 16), except that active-tracking based system 1800 implements (a) position sensing module 1310 as position sensing module 1704 (FIG. 17), and (b) camera module 1330 as camera module 1612 (FIG. 16).

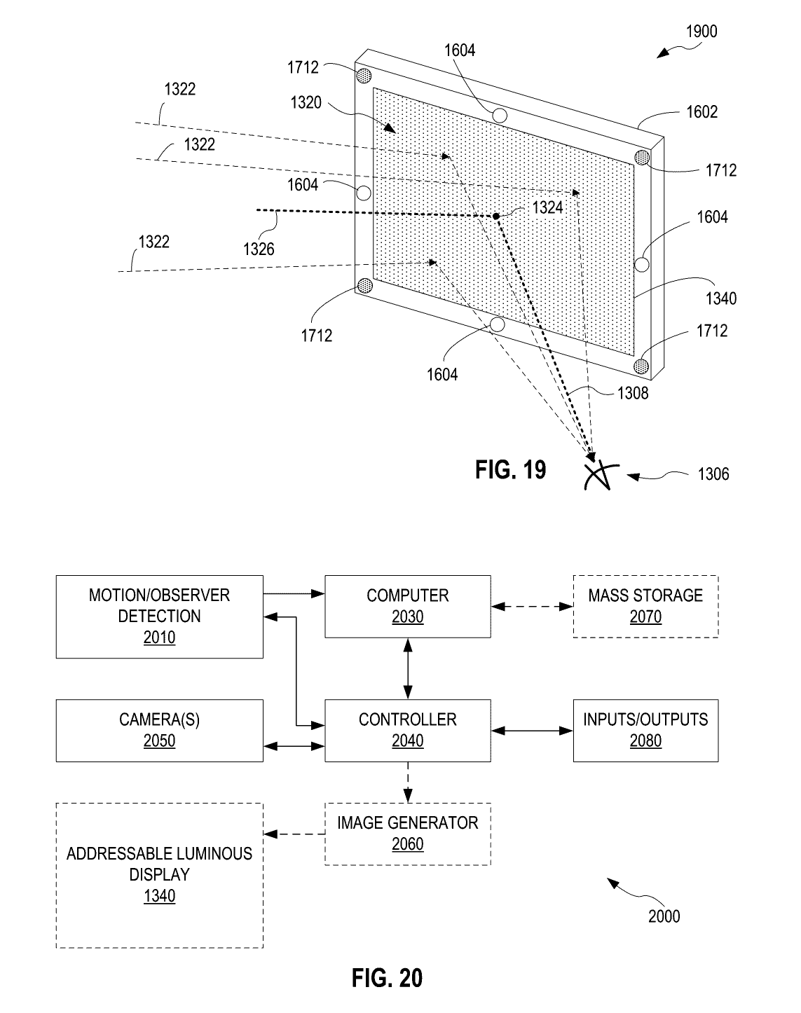

FIG. 19 illustrates one exemplary active-tracking based system 1900 for generating, and optionally displaying, mirror image 1390 (FIG. 13) and may implement active-tracking based method 1400 (FIG. 14). Active-tracking based system 1900 is an embodiment of active-tracking based system 1300. Active-tracking based system 1900 is similar to active-tracking based system 1600 (FIG. 16), except that active-tracking based system 1900 implements camera module 1330 with camera devices 1712 (FIG. 17) instead of implementing camera module 1612.

FIG. 20 illustrates one exemplary active-tracking based system 2000 for generating, and optionally displaying, mirror image 1390 (FIG. 13). Active-tracking based system 2000 is an embodiment of active-tracking based system 1300.

Active-tracking based system 2000 includes addressable luminous display 1340 and a motion and observer detection sub-system 2010, both of which may be operatively coupled to a computer 2030 and/or to a controller 2040. Motion/observer detection sub-system 2010 includes at least one motion detection device (such as position sensor(s) 1312) that employs electromagnetic radiation, sonic or ultrasonic technology, thermal imaging technology, or any means of detecting and tracking the presence of a human being or observer. For example, such motion detection device(s) may employ an optical camera together with image processing algorithms implemented on computer 2030 which automatically detect and recognize the presence of an observer such as in one example a human being and extract observer features, such as the eyes and/or other facial features; from which a position vector 1308 maybe estimated. Motion/observer detection sub-system 2010 and associated computer program, executed by computer 2030, extract features from identified moving object to define position vector 1308. Computer 2030 processes data from motion/observer detection sub-system 2010 and generates a position vector estimate 1308, which is input to controller 2040.

In one embodiment, controller 2040 controls direction-adjustable optical device(s) and/or camera(s) 1612 (FIG. 16) and orients it to a direction such that the scene being imaged by optical device(s) 1612 is substantially the scene that would be seen by observer 1306 were display 1340 replaced by an optical mirror.

In another embodiment, controller 2040 determines, based upon position vector 1308, viewing direction 1326, and synthesizes, based upon viewing direction 1326, mirror image 1390 from a collection of optical input images from one or a plurality of fixed or adjustable camera devices 1712 (FIG. 17). In one example, the plurality of camera devices 1712 are substantially fixed with respect to the active-tracking based system. In another example, each or a subset of the camera devices 1712 may be independently oriented as a function of the position vector 1308 and of the sensor's known position on the active-tracking based system. The generation of mirror image 1390 is carried out by computer 2030 or optional image generator 2060 using image processing techniques known in the art such as image stitching, image merging, image fusion, and similar; and enables the correction for optical parallax and other effects known in optics, and the generation of mirror image 1390 simulating that that would be generated for the observer by a passive mirror surface of known extent and location.

Mirror image 1390 may be displayed on optional display 1340 and may represent a scene substantially similar to what observer 1306 would see were display 1340 replaced by an optical mirror. Mirror image 1390 may also in parallel be stored in optional mass storage 2070 for later viewing or processing, or for remote transmission. Inputs and outputs to and from active-tracking based system 2000 are achieved through input and output functionality represented by interface 2080. Input and output functionalities include user settings; links to an image data base; and a “live data” link for the reception of remotely acquired scene data.

Without departing from the scope hereof, motion/observer detection sub-system 2010 may not detect motion of observer 1306, but rather detect another indication of the presence, and optionally location, of observer 1306.

Motion/observer detection sub-system 2010 and at least a portion of computer 2030 form an embodiment of position sensing module 1310. Camera(s) 2050, controller 2040, and, optionally, image generator 2060 form an embodiment of camera module 1330.

Without departing from the scope hereof, mirror image 1390 may be only one component of the scene that is presented on display 1340. For illustration, other information, including other image input streams, may be combined and/or merged with mirror image 1390 to generate the image displayed by addressable active display.

In one embodiment, a remote user of active-tracking based system 2000 specifies a direction in space as corresponding to the position of an observer 1306, whether or not a physical observer 1306 is present in the system proximity. In one example, this remote user utilizes remote control system 1380. The remote user may specify a raster sequence of three-dimensional vector corresponding to a “virtual” observer, as discussed in reference to FIGS. 13 and 14.

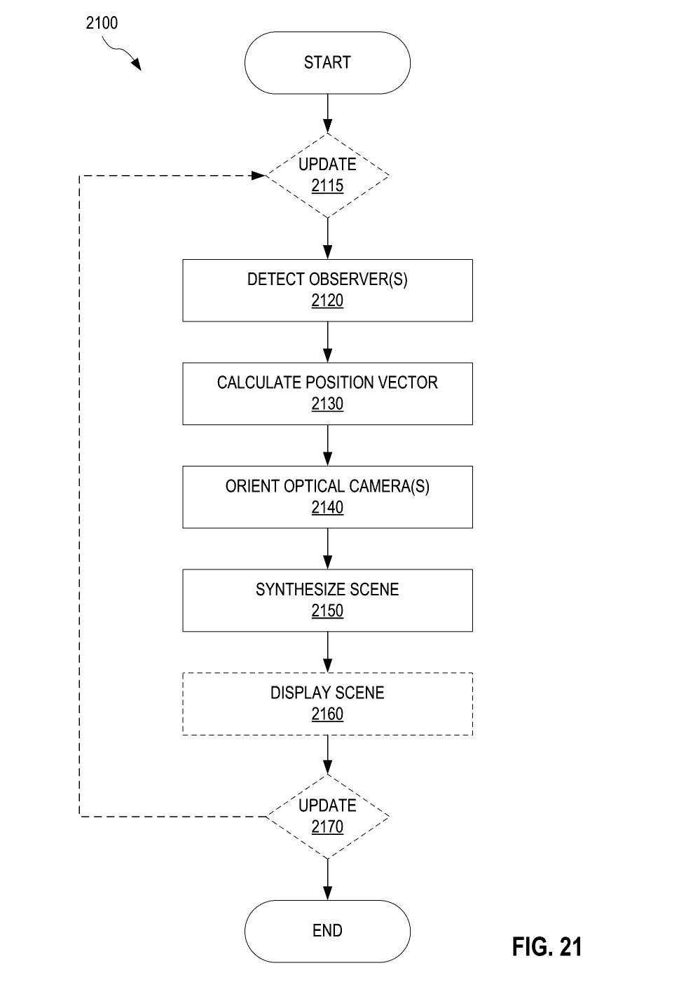

FIG. 21 illustrates one exemplary active-tracking based method 2100 for generating, and optionally displaying, mirror image 1390 (FIG. 13) using at least one rotatable camera device. Active-tracking based method 2100 is an embodiment of active-tracking based method 1400 (FIG. 14). Active-tracking based method 2100 is performed by, for example, active-tracking based system 1300, 1600 (FIG. 16), 1700 (FIG. 17), 1800 (FIG. 18), 1900 (FIG. 19), or 2000 (FIG. 20).

In a step 2120, method 2100 detects the presence of observer 1306. In one example of step 2120, at least one position sensor 1312 detects the presence of observer 1306. In another example of step 2120, motion/observer detection sub-system 2010 detects the presence of observer 1306.

In a step 2130, method 2100 calculates position vector 1308. In one example of step 2130, position sensing module 1310 calculates position vector 1308 based upon measurements by position sensor(s) 1312. In another example of step 2130, computer 2030 calculates position vector 1308 based upon data received from motion/observer detection sub-system 2010.

In a step 2140, method 2100 orients, based upon position vector 1308, at least one camera device 1332 along a respective direction to capture a respective image, such that the scene observed and/or synthesized by/from such image(s) substantially corresponds to the scene that observer 1306 would observe were display 1340 replaced by a reflective or semi-reflective surface of known shape, known orientation and known position with respect to display 1340. As described above, step 2140 may utilize camera module 1330 implemented with one or a plurality of camera devices 1332, wherein at least some of the plurality of optical cameras may have different optical axes orientations. In one example of step 2140, display device 1602 rotates camera module 1612 or one or more camera devices 1712 along viewing direction 1326. In another example of step 2140, controller 2040 rotates camera(s) 2050 along viewing direction 1326.

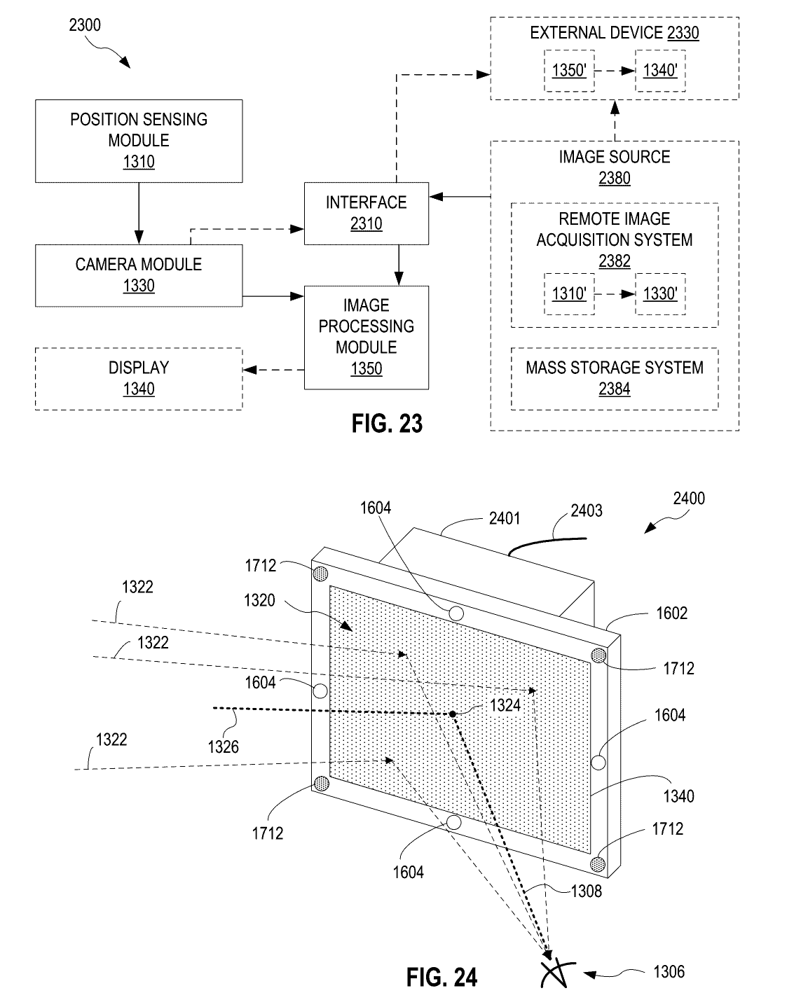

In a step 2150, method 2100 synthesizes mirror image 1390 from one or more images captured by the camera device(s) oriented in step 2140. In one embodiment, mirror image 1390 is at least a portion of an image captured by one camera device in step 2140. In another embodiment, step 2150 synthesizes mirror image 1390 from a plurality of images captured by a respective plurality of camera devices in step 2140. Step 2150 may further merge mirror image 1390 with a second image 1352, different from image(s) captured in step 2140, to produce a merged image that includes at least a portion of mirror image 1390 and a portion of image 1352. Examples of such image merging are discussed below in reference to FIGS. 23-29. Without departing from the scope hereof, image 1352 may be a void image, such that the merged image is mirror image 1390. In one example of step 2150, camera module 1330 outputs, as mirror image 1390, at least a portion of an image captured by a rotatable embodiment of camera device 1332. In another example of step 2150, image generator 1334 synthesizes mirror image 1390 from a plurality of images captured by a plurality of rotatable embodiments of camera device 1332. Optionally, image processing module 1350 merges mirror image 1390 with a second image 1352 to produce a merged image that includes a portion of mirror image 1390 and a portion of image 1352. In yet another example of step 2150, computer 2030 synthesizes mirror image 1390 from (a) one image captured in step 2140, (b) a plurality of images captured in step 2140, or (c) one or more images captured in step 2140 and a second image 1352 retrieved from mass storage 2070 or received from interface 2080.

In an optional step 2160, method 2100 displays, on display 1340, mirror image 1390 or a merged image including at least a portion of mirror image 1390 and a portion of image 1352.

In one embodiment, method 2100 includes a step 2170 that directs method 2100 to an update step 2115, thus repeating steps 2120, 2130, 2140, 2150, and optionally 2160. In this embodiment, method 2100 generates a stream of mirror images 1390 or a stream of images each including at least a portion of a corresponding mirror image 1390. Thereby, method 2100 may dynamically update display 1340 in accordance with a possibly varying location of observer 1306.

At least a portion of method 2100 may be implemented as machine-readable instructions encoded on non-transitory media within active-tracking based system 1300.

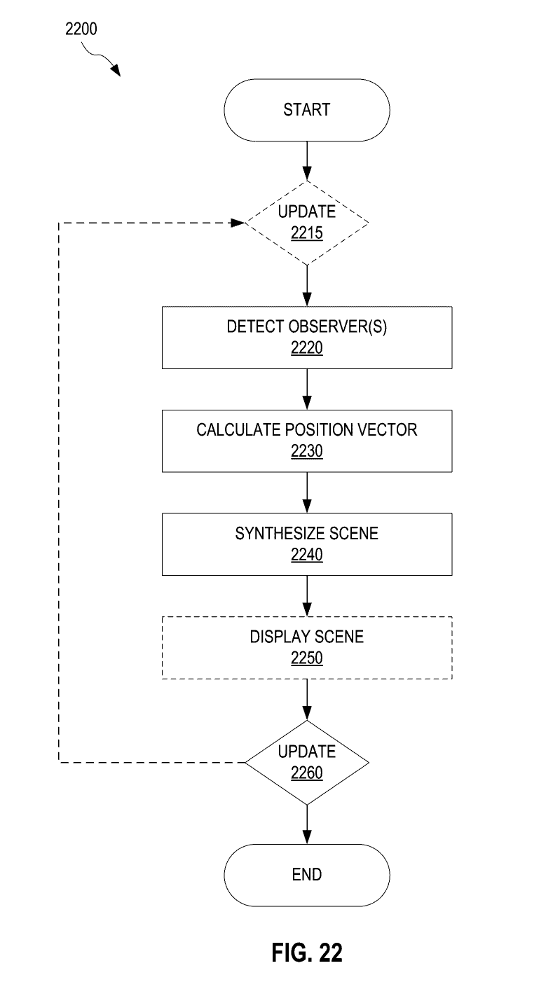

FIG. 22 illustrates one exemplary active-tracking based method 2200 for generating, and optionally displaying, mirror image 1390 (FIG. 13) using a plurality of camera devices 1332. Each camera device 1332 may be implemented as a stationary or rotatable camera device. Active-tracking based method 2100 is an embodiment of active-tracking based method 1400 (FIG. 14). Active-tracking based method 2100 is performed by, for example, active-tracking based system 1300, 1600 (FIG. 16), 1700 (FIG. 17), 1800 (FIG. 18), 1900 (FIG. 19), or 2000 (FIG. 20).

In a step 2220, method 2200 detects the presence of observer 1306. Step 2220 is similar to step 2120 (FIG. 21).

In a step 2230, method 2200 calculates position vector 1308. Step 2230 is similar to step 2130 (FIG. 21).

In a step 2240, method 2200 captures a plurality of images using a respective plurality of camera devices 1332, and synthesizes mirror image 1390 from this plurality of images. Step 2250 may further merge mirror image 1390 with a second image 1352 to produce a merged image that includes at least a portion of mirror image 1390 and a portion of image 1352 different from any of the plurality of images captured in step 2240. Without departing from the scope hereof, image 1352 may be a void image, such that the merged image is mirror image 1390. In one example of step 2240, image generator 1334 synthesizes mirror image 1390 from a plurality of images captures by a plurality of camera device 1332. Optionally, image processing module 1350 merges mirror image 1390 with a second image 1352 to produce a merged image that includes a portion of mirror image 1390 and a portion of image 1352. In another example of step 2240, computer 2030 synthesizes mirror image 1390 from (a) a plurality of images captured in step 2240, or (b) a plurality of images captured in step 2240 and a second image 1352 retrieved from mass storage 2070 or received from interface 2080.

In an optional step 2250, method 2200 displays, on display 1340, mirror image 1390 or a merged image including at least a portion of mirror image 1390 and a portion of a second image 1352.

In one embodiment, method 2200 includes a step 2260 that directs method 2200 to an update step 2215, thus repeating steps 2220, 2230, 2240, and optionally 2250. In this embodiment, method 2200 generates a stream of mirror images 1390 or a stream of images each including at least a portion of a corresponding mirror image 1390. Thereby, method 2200 may dynamically update display 1340 in accordance with a possibly varying location of observer 1306.

At least a portion of method 2200 may be implemented as machine-readable instructions encoded on non-transitory media within active-tracking based system 1300.

FIG. 23 illustrates one exemplary active-tracking based system 2300 for generating, and optionally displaying, a mirror image 1390 (FIG. 13), and which includes merge and record functions. Active-tracking based system 2300 is similar to active-tracking based system 1300.

As compared to active-tracking based system 1300, active-tracking based system 2300 includes image processing module 1350 and an interface 2310. Interface 2310 receives an external image stream from an image source 2380.

Active-tracking based system 2300 operates position sensing module 1310 and camera module 1330, as discussed in reference to FIG. 13, to produce mirror image 1390. Image processing module 1350 receives, via interface 2310, an external image from image source 2380. Image processing module 1350 merges this external image with mirror image 1390 to generate a merged image. Optionally, image processing module 1350 displays this merged image on optional display 1340.

Optionally, active-tracking based system 2300 includes image source 2380. In one embodiment, image source 2380 includes remote image acquisition system 2382. Remote image acquisition system 2382 may be similar to active-tracking based system 1300 and thus include a position sensing module 1310′ and a camera module 1330′. Position sensing module 1310′ and camera module 1330′ are similar to position sensing module 1310 and camera module 1330. In an exemplary use scenario associated with this embodiment, the external image received from image source 2380 is at least a portion of a mirror image 1390′ generated by remote image acquisition system 2382, wherein mirror image 1390′ is similar to mirror image 1390. In another embodiment, image source 2380 includes a mass storage system 2384 that holds one or more images to be used by image processing module 1350.

In one embodiment, interface 2310 is configured to output images generated by camera module 1330 and/or image processing module 1350 to an external device 2330. Interface 2310 may output mirror image 1390 generated by camera module 1330 to external device 2330. External device 2330 may include an image processing module 1350′ and a display 1340′, which are similar to image processing module 1350 and a display 1340, respectively. Image processing module 1350′ may receive mirror image 1390, or a portion thereof, generated by camera module 1330, and merge mirror image 1390 with an image received from image source 2380. External device 2330 may display the resulting merged image on display 1340′.

Without departing from the scope hereof, active-tracking based system 2300 may merge streams of images.

FIG. 24 illustrates one exemplary active-tracking based system 2400 for generating, and optionally displaying, a mirror image 1390 (FIG. 13), and which includes merge and record functions. Active-tracking based system 2400 is an embodiment of active-tracking based system 2300 (FIG. 23).

Although shown in FIG. 24 as (a) implementing position sensing module 1310 and camera module 1330 as discussed in reference to FIG. 19, active-tracking based system 2400 may utilize other implementations of position sensing module 1310 and camera module 1330, without departing from the scope hereof. Active-tracking based system 2400 may implement position sensing module 1310 and camera module 1330 as discussed in reference to FIGS. 16-18.

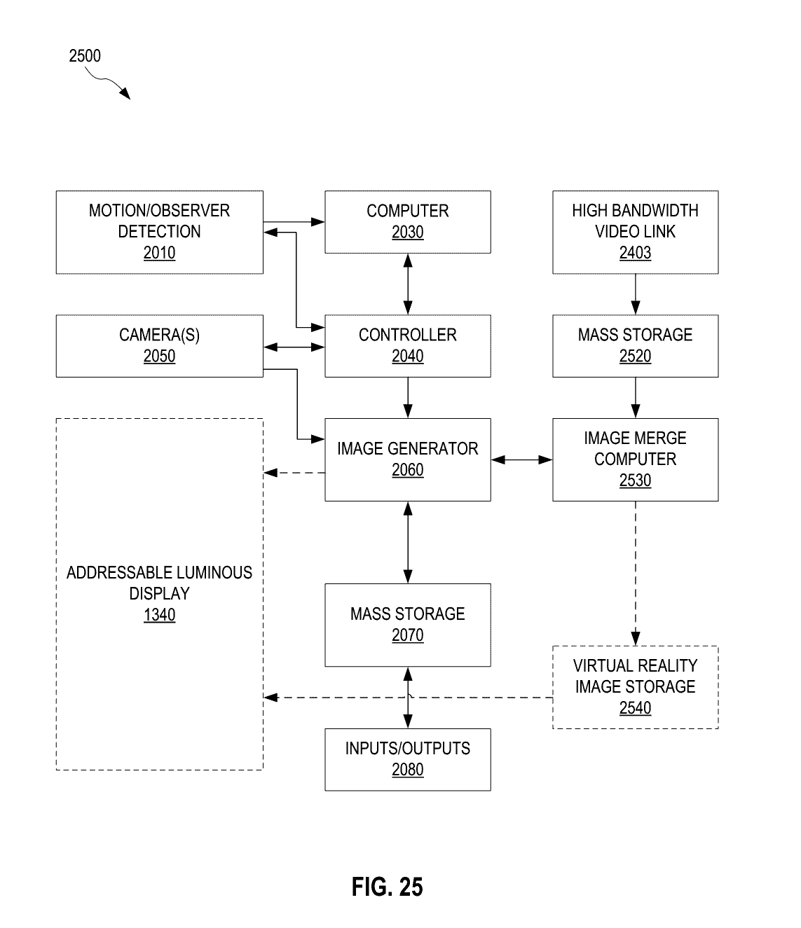

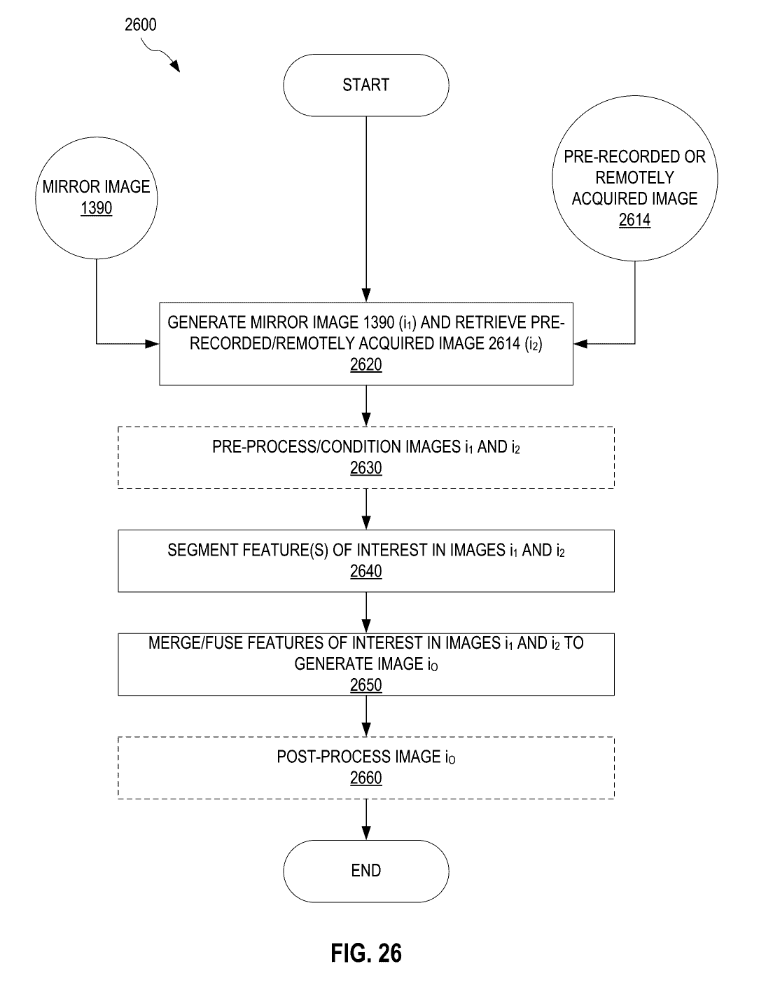

As compared to active-tracking based system 1900, active-tracking based system 2400 further includes a high-bandwidth link 2403 to interface with remote image acquisition systems and also a mass storage system (not shown), such as image source 2380. A computer implemented in a sub-system 2401 performs the image merge and storage functions, as discussed in reference to FIG. 23 or as further described below in reference to FIGS. 25 and 26.

FIG. 25 illustrates one exemplary active-tracking based system 2500 for generating, and optionally displaying, mirror image 1390 (FIG. 13), and which includes merge and record functions. Active-tracking based system 2500 is an embodiment of active-tracking based system 2300 (FIG. 23).

Active-tracking based system 2500 is similar to active-tracking based system 2000 (FIG. 20). As compared to active-tracking based system 2000, active-tracking based system 2500 includes (a) image generator 2060 and (b) mass storage 2070 that stores images generated by image generator 2060. Interface 2080 enables interaction with a user for various system settings and options. The merge and record components include (a) a high-bandwidth video link 2403 to communicate with external and/or remote image sequences sources (such as image source 2380), (b) a mass storage 2520 to store associated data, (c) an image merge computer 2530 which performs the merging of two input images, one generated by active-tracking based system 2500 from images captured by camera(s) 2050, the other one previously stored on mass storage 2520 or remotely acquired and transmitted via video link 2403. Image merge computer 2530 provides as output a “virtual reality” image comprising features extracted and possibly subsequently modified via image processing from both input images. The resulting output virtual reality image may be stored on an optional virtual reality image storage 2540 and/or sent to optional display 1340 for presentation to a user, such as observer 1306. Although shown in FIG. 25 as being separate computers, a single computer may implement computer 2030 and image merge computer 2530. Similarly, virtual reality image storage 2540 and mass storage 2070 may be implemented as a single storage device. High-bandwidth video link 2403 includes, for example, a co-axial cable, a Wi-Fi antenna, an Ethernet cable, a fiber optic cable, or any other means of transferring data appropriate for the high-bandwidth generally required for the transmission of image information.

Without departing from the scope hereof, active-tracking based system 2500 may include only one of high-bandwidth video link 2403 and mass storage 2520.

FIG. 26 illustrates one exemplary method 2600 for merging two input images. Method 2600 is performed by active-tracking based system 2300 (FIG. 23), for example. Method 2600 is an embodiment of method 1400 that includes step 1444.

In a step 2620, method 2600 generates mirror image 1390 (i₁) and retrieves a pre-recorded or remotely acquired image 2614 (i₂). In the following, method 2600 is discussed in the context of merging a single mirror image 1390 with a single pre-recorded or remotely acquired image 2614. However, it is understood that method 2600 may be utilized to merge mirror image 1390 with pre-recorded or remotely acquired image 2614, for respective streams of mirror image 1390 and pre-recorded or remotely acquired image 2614.

In one example of step 2620, position sensing module 1310 and camera module 1330 of active-tracking based system 2300 (FIG. 23) cooperate to generate mirror image 1390. Next, in this example, image processing module 1350 (a) retrieves mirror image 1390 from camera module 1330 and (b) retrieves a pre-recorded or remotely acquired image 2614 from image source 2380 via interface 2310. In another example of step 2620, motion/observer detection sub-system 2010, camera(s) 2050, and optionally image generator 2060 cooperate to generate mirror image 1390. Next, in this example of step 2620, image merge computer 2530 (FIG. 25) (a) retrieves mirror image 1390 from image generator 2060 (or directly from camera(s) 2050), and (b) retrieves a pre-recorded or remotely acquired image 2614 from mass storage 2520 or high-bandwidth video link 2403 (FIG. 24).

In one scenario, pre-recorded or remotely acquired image 2614 is generated by another active-tracking based system for generating, and optionally displaying, a mirror image. For example, a remotely acquired image 2614 is produced from one or more images captured simultaneously with the one or more images used to generate mirror image 1390.

When processing image sequences, step 2620 may utilize user inputs and/or automated image sequence analysis to determine which images of the image sequences to process.

In an optional step 2630, method 2600 preprocesses mirror image 1390 and pre-recorded or remotely acquired image 2614. Step 2630 includes applications of algorithms that will help the subsequent step of image segmentation for the extraction of features of interest. Accordingly, the applied algorithms may be task dependent. Often a high-pass filter is applied to an image when one is interested in finding object/feature edges. In other situations, cross-correlations with a specific set of image pattern templates are calculated. Use of a-priori information is known to lead to better image segmentation performance. The field of computer vision has grown enormously in the last twenty years, and many techniques and algorithms are available for pre-processing and segmenting images, as known in the art. Examples of text books pertaining to the field include “Computer Vision” by D H Ballard and C M Brown (Prentice Hall, 1982) and “Computer Vision: Algorithms and Applications” by R Szeliski (Springer, 2011). In one example of step 2630, image processing module 1350 of active-tracking based system 2300 pre-processes mirror image 1390 and pre-recorded or remotely acquired image 2614. In another example, image merge computer 2530 processes mirror image 1390 and pre-recorded or remotely acquired image 2614.

In a step 2640, method 2600 segments features from mirror image 1390 and pre-recorded or remotely acquired image 2614. In one scenario, step 2640 segments out and retains from pre-recorded or remotely acquired image 2614 a feature of interest, such as the body and face of a remote interlocutor (e.g., an observer 1306 of a remote active-tracking based system for generating, and optionally displaying, a mirror image). In this scenario, mirror image 1390 then serves as the background upon which such feature of interest is superimposed. Step 2640 is performed, for example, by image processing module 1350 of active-tracking based system 2300 or by image merge computer 2530.

In a step 2650, the features of interest segmented out in step 2640 are merged together, to create a synthetic output image i_{O}. For example, referring to the exemplary discussed in reference to step 2640, the person in remote communication via video link would appear with, as a background, mirror image 1390. Step 2740 may include processing steps to ensure that the generated image looks natural to the local observer. For example, a region of the image outside the segmented features from the remote video images may be defined, and the pixel values in that region may be calculated so that a smooth transition occurs across the two sub-image boundaries. As indicated above more generally with respect to the field of computer vision, there exist a number of approaches that may be applied to ensure such a result. Step 2650 may utilize such approaches. Step 2650 is performed, for example, by image processing module 1350 of active-tracking based system 2300 or by image merge computer 2530.

In an optional step 2660, method 2600 applies post-processing to the merged image i_{O}, to ensure that the merged image i_{O} possesses specific/desirable properties for display to the local observer 1306. Step 2660 is performed, for example, by image processing module 1350 of active-tracking based system 2300 or by image merge computer 2530.

Although not shown in FIG. 26, merged image i_{O} may be stored to memory of the active-tracking based system or displayed on display 1340 of the active-tracking based system, without departing from the scope hereof. In one exemplary use scenario, the active-tracking based system operates on sequences of images that are presented in a video mode. Method 2600 may account for the temporal relationship between subsequent images, for example as is known in the art. In one example, the result of one image segmentation may be used as an input in the processing for segmenting the next image in a sequence.

Without departing from the scope hereof, method 2600 may be utilized in other applications, for example applications wherein an image stream is transferred over a reduced-bandwidth connection. For example, segmentation of a remotely acquired image 2614 in step 2640 may be performed by the remote system, thereby decreasing bandwidth requirements to high-bandwidth link 2403.

In one scenario, active-tracking based system 2300 (FIG. 23) implements method 2600 to generate a virtual reality sequence of images. In this scenario, method 2600 may utilize a sequence of pre-recorded images 2614. In another scenario, two active-tracking based systems 2300 (FIG. 23), communicatively coupled with each other, implement method 2600 to facilitate a live video conference between to corresponding observers 1306. In this scenario, active-tracking based system 2300 utilizes method 2600 to enable communication between the two observers 1306 with a much enhanced sense of presence: a live image of the remote participant being presented to the local participant as being part of his/her local environment.

At least a portion of method 2600 may be implemented as machine-readable instructions encoded on non-transitory media within active-tracking based system 1300.

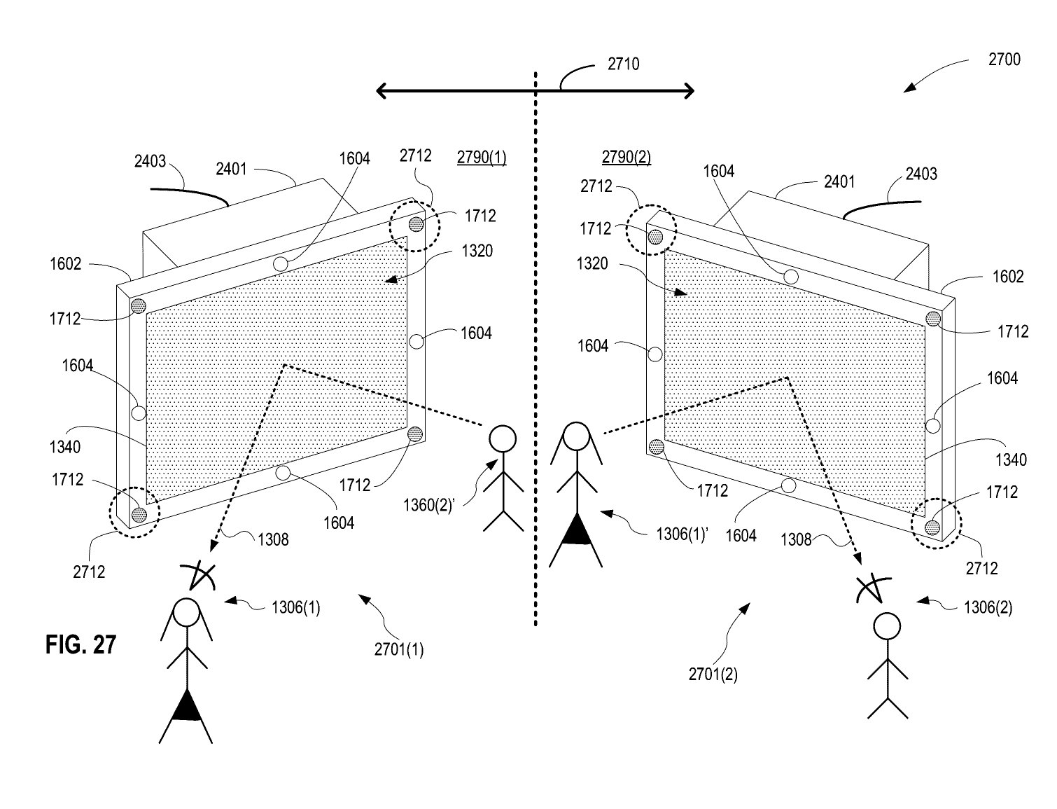

FIG. 27 illustrates one exemplary live-video conference system 2700 that includes two communicatively coupled active-tracking based systems 2701 (FIG. 23) for displaying a mirror image and with merge and record functions. Each active-tracking based system 2701 is an embodiment of active-tracking based system 2300 (FIG. 23) and utilizes a stream of remotely acquired images 2614, generated by the other active-tracking based system 2701, to perform method 2600 (FIG. 26). Although shown in FIG. 27 as being implemented as active-tracking based system 2400 (FIG. 24), each active-tracking based system 2701 may be implemented as another embodiment of active-tracking based system 2300, without departing from the scope hereof.

Active-tracking based system 2701(1) is located in an environment 2790(1) and is viewed by an observer 1306(1). Active-tracking based system 2701(2) is located in an environment 2790(2) and is viewed by an observer 1306(2). Active-tracking based systems 2701(1) and 2701(2) are communicatively coupled via a high-bandwidth video link 2710 compatible with interfacing with high-bandwidth video link 2403 of each of active-tracking based systems 2701(1) and 2701(2).

Active-tracking based system 2701(1) includes at least one camera device 1712 that captures images to generate a stream of mirror images 1390 for environment 2790(1), based upon position vector 1308 associated with observer 1306(1), as discussed for example in reference to FIG. 14. Active-tracking based system 2701(1) also includes at least one camera device 1712 (for example the two camera devices 1712 labeled 2712) that captures a stream of images of observer 1306(1), or a stream of images from which a stream of images of observer 1306(1) may be generated. Active-tracking based system 2701(1) may utilize position sensing module 1310, implemented with position sensors 1604, to determine the position of observer 1306(1) and actively track observer 1306(1), to produce a stream of images of observer 1306(1). In one example, the images of observer 1306(1) are generated in a manner similar to the generation of mirror images 1390 in steps 1420 and 1430 of method 1400, except that the images of observer 1306(1) represent a view along position vector 1308 instead of viewing direction 1326. The stream of images of observer 1306(1) is communicated, via high-bandwidth link 2710, to active-tracking based system 2701(2). Active-tracking based system 2701(2) implements the image stream of observer 1306(1) in method 2600 as a stream of remotely acquired images 2614.

Likewise, active-tracking based system 2701(2) includes at least one camera device 1712 that captures images to generate a stream of mirror images 1390 for environment 2790(2), based upon position vector 1308 associated with observer 1306(2), as discussed for example in reference to FIG. 14. Active-tracking based system 2701(2) also includes at least one camera device 1712 (for example the two camera devices 1712 labeled 2712) that captures a stream of images of observer 1306(2), or a stream of images from which a stream of images of observer 1306(2) may be generated, as discussed above in reference to active-tracking based system 2701(1). This stream of images of observer 1306(2) is communicated, via high-bandwidth link 2710, to active-tracking based system 2701(1). Active-tracking based system 2701(1) implements the image stream of observer 1306(2) in method 2600 as a stream of remotely acquired images 2614.

In one embodiment, each active-tracking based system 2701 utilizes one camera device 1712 (or one set of camera devices 1712) to capture images used to generate mirror image 1390, and another camera device 1712 (or another set of camera devices 1712) to capture images of the local observer 1306. In another embodiment, each active-tracking based system 2701 captures images used generate mirror image 1390 and images of the local observer 1306 using the same camera device 1712 or the same set of camera devices 1712.

Active-tracking based system 2701(1) performs method 2600, utilizing the image stream of observer 1306(2), to provide a “virtual reality” image stream wherein remote observer 1306(2) is seen as if immersed within the local environment 2790(1), as indicated by observer 1306(2)′. Similarly, active-tracking based system 2701(2) performs method 2600, utilizing the image stream of observer 1306(1), to provide a “virtual reality” image stream wherein remote observer 1306(1) is seen as if immersed within the local environment 2790(2), as indicated by observer 1306(1)′.

Accordingly, telecommunication participants 1306(1) and 1306(2) are connected live through the linked active-tracking based systems 2701(1) and 2701(2), and live-video conference system 2700 provides a “virtual reality” image wherein the remote participants are seen as if they were immersed within the local environment of their interlocutors.

Without departing from the scope hereof, each or one of environments 2790(1) and 2790(2) may be associated with a plurality of observers 1306. In this scenario, cameras(s) 1712 may generate (a) separate image streams of each of the plurality of observers or (b) a single image stream including the plurality of observers, wherein each image of the single image stream is segmented to extract an image of each of the plurality of observers.

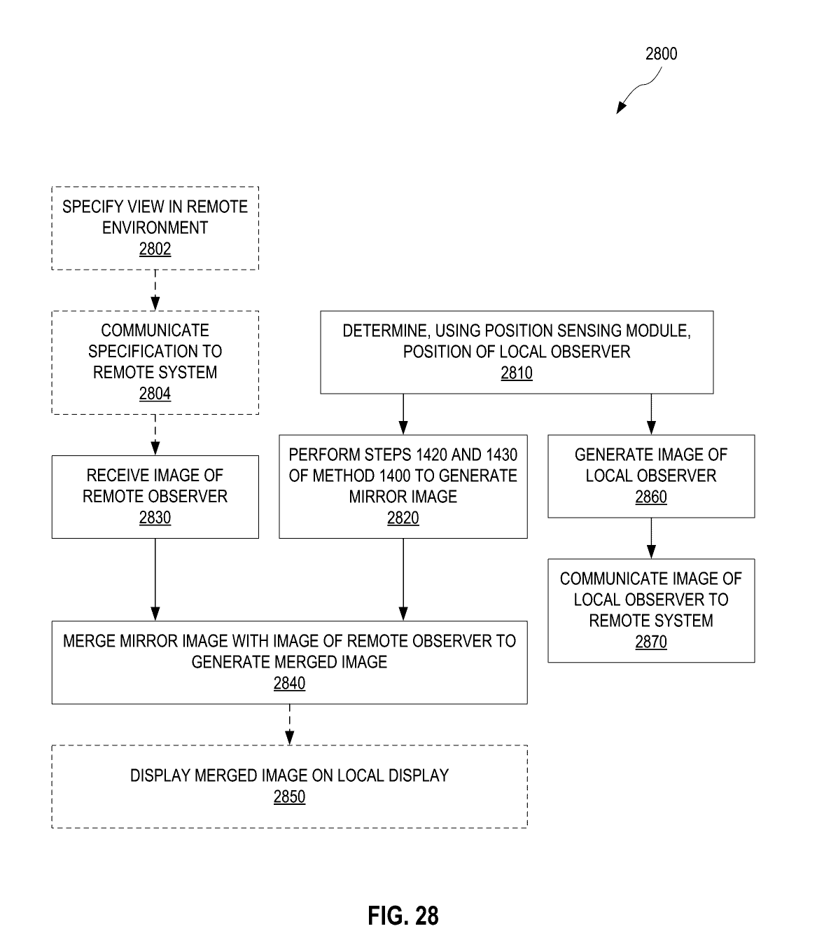

FIG. 28 illustrates one exemplary active-tracking based method 2800 for generating live video conference imagery. Method 2800 is performed by live video conference system 2700 (FIG. 27). FIG. 28 shows the steps performed by a single active-tracking based system 2701. It is understood that each active-tracking based system 2701 of live video conference system 2700 performs the steps shown in FIG. 28. Live video conference system 2700 may perform method 2800 repeatedly to generate a live video conference image stream.

In a step 2810, position sensing module 1310 (FIG. 13) of the local active-tracking based system 2701 determines the position of the local observer 1306, as discussed in reference to step 1410 of method 1400 (FIG. 14). In a step 2820, method 2800 performs steps 1420 and 1430 to generate mirror image 1390 for the local observer 1306, as discussed in reference to FIG. 14. In a step 2830, the local active-tracking based system 2701 receives an image of the remote observer 1306, as discussed in reference to FIG. 27. In a step 2840, the local active-tracking based system merges mirror image 1390 with the image of the remote observer 1306 to produce a merged image, as discussed in reference to FIG. 27. Optionally, this merged image is displayed on a display of the local active-tracking based system 2701 in a step 2850, as discussed in reference to FIG. 27. In a step 2860, the local active-tracking based system 2701 generates an image of the local observer 1306, as discussed in reference to FIG. 27. In a step 2870, the local active-tracking based system 2701 communicates this image of the local observer 1306 to the remote active-tracking based system 2701, as discussed in reference to FIG. 27.

In certain embodiments, active-tracking based method 2800 allows local observer 1306 to specify a view associated with the image received in step 2830. In such embodiments, method 2800 includes steps 2802 and 2804. In step 2802, local observer 1306 (or another operator or operating system associated with local active-tracking based system 2701) specifies a view in remote environment 2790. In step 2804, local active-tracking based system 2701 communicates this view specification to remote active-tracking based system 2701, such that remote active-tracking based system 2701 generates the image of step 2830 according to the specification of step 2802. The view specified in step 2802 need not coincide with a physical, remote observer 1306. In one example of step 2802, the view corresponds to a view of interest in remote environment 2790. In another example, active-tracking based method 2800 performs step 2802 repeatedly to perform a raster scan in remote environment 2790. This raster scan may serve to search, and optionally locate, an object of interest such as a human observer 1306. Optionally, after locating this object of interest, remote active-tracking based system 2701 may continue to actively track this object of interest, using position sensing module 1310, to generate a stream of images of this object of interest to be used in step 2830.

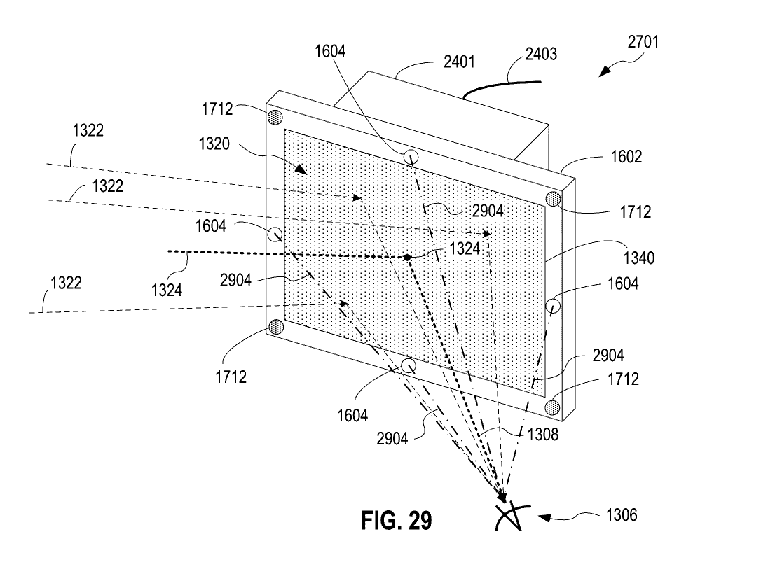

FIG. 29 illustrates generation of a three-dimensional model of an observer 1306 (FIG. 13) by active-tracking based system 2701 of live video conference system 2700 (FIG. 27). This three-dimensional model may be utilized in step 2860 of method 2800 (FIG. 28) to further enhance the rendition of a local observer 1306.

In the following description it is assumed that position sensors 1604, or at least a subset of a multiplicity of position sensors 1604 comprise a video camera. A three-dimensional model of the local observer 1306 may be generated, as known in the art, in at least two ways. In one embodiment, because the same observer 1306 is seen over time by at least one position sensor 1604 of active-tracking based system 2701, such as position sensing module 1704 of FIG. 17 (which is, for the purpose of FIG. 29, understood to also include an optical camera), the observer will be seen over time (due to his own motion during that time) at a variety of angles and orientations with respect to such camera, thus allowing the definition and progressive refinement of a three-dimensional model of the local observer 1306. In another embodiment, active-tracking based system 2701 includes a plurality of camera devices 1712 arranged at a plurality of locations on active-tracking based system 2701. A subset of the image streams supplied by those camera devices 1712 will contain the observer. These camera devices 1712 de-facto provide views of the local observer 1306 at a variety of angles and orientations. In this embodiment, this plurality of views is used to generate a three-dimensional model of the local observer 1306, as known in the art.

Active-tracking based system 2701 may leverage both of these two methods, in combination, to define a further improved three-dimensional model as compared to a model that could be obtained from only one of them. In one such example, position sensors 1604 also include an optical sensor/camera. Position sensors 1604 then provide optical input video streams of the local observer 1306 at a variety of angles 2904. Active-tracking based system 2701 may then analyze and process these input video streams to generate a three-dimensional model of the local observer 1306. This three-dimensional model, in turn, may be remotely transmitted for further display enhancement to a remote user of remote active-tracking based system 2701 or other display system capable of leveraging the additional information provided by the three-dimensional model thus generated.

It is understood that in the above description, any sensor or optical device comprising a video camera, such as camera device 1332 or certain embodiments of position sensor 1312, may contribute image information about observer 1306 that may be leveraged for the generation of a three-dimensional model of observer 1306.

The three-dimensional model in turn may be transmitted to a remote video-conference participant, and utilized to enhance the virtual-reality representation of the observer to the remote participant. Display systems capable of representing three-dimensional information are known in the art, such as (but not limited to) systems where the observer wears google with light wave-length specific response. Many different technologies are applicable to the goal of enhancing the three-dimensional perception of a scene, as known in the art, and apply to active-tracking based system 2701 as well as other embodiments of active-tracking based system 1300.

Corresponding reference numerals indicate corresponding parts throughout the several views of the drawings.

An embodiment of the present invention may be obtained in the form of computer-implemented processes and apparatuses for practicing those processes. The present invention may also be embodied in the form of a computer program product having computer program code containing instructions embodied in tangible media, such as floppy diskettes, CD-ROM, hard drives, digital video disks, USB (universal serial bus) drives, or any other computer readable storage medium, such as random access memory (RAM), read only memory (ROM), or erasable programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic waves and radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to generate a two-dimensional image representative of what an observer would see were the display surface to be replaced by an optical mirror of known shape and orientation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of terms first, second, etc. do not denote any order of importance, but rather the terms first, second, etc. are used to distinguish one element from another. Furthermore, the use of terms a, an, etc. do not denote a limitation of quantity, but rather denote the presence of at least one of the referenced item.

List of Exemplary Embodiments of Active-Tracking Based Systems and Methods for Generating a Mirror Image:

(A1) An active-tracking based system for generating a mirror image may include a position sensing module for determining position of an observer relative to a surface, and a camera module for generating the mirror image based upon the position, as the mirror image would have been experienced by the observer if the surface had been a mirror.

(A2) The active-tracking based system denoted as (A1) may further include a display for displaying the mirror image.

(A3) In the active-tracking based system denoted as (A2), the display coinciding with the surface.

(A4) In any of the active-tracking based systems denoted as (A1) to (A3), the surface may be a virtual surface of known shape, orientation, and location.

(A5) In any of the active-tracking based systems denoted as (A1) through (A4), the camera module may include at least one rotatable camera device for being oriented, according to the position of the observer, to capture an image along viewing direction associated with the mirror image.

(A6) In any of the active-tracking based systems and methods denoted as (A1) through (A4), the camera module may include a plurality of camera devices located at a respective plurality of different locations, and the active-tracking based system may further include an image generator for processing a plurality of images captured by the plurality of camera devices, respectively, to generate the mirror image.

(A7) In the active-tracking based system denoted as (A6), each of the plurality of camera devices may have fixed orientation.

(A8) In the active-tracking based system denoted as (A6), at least one of the plurality of camera devices may be rotatable.

(A9) In any of the active-tracking based systems denoted as (A1) through (A8), the position sensing module may include a rotatable position sensor for being oriented, according to the position of the observer, to actively track the position of the observer.

(A10) In any of the active-tracking based systems denoted as (A1) through (A8), the position sensing module may include a plurality of position sensors for cooperatively determining the position of the observer.

(A11) Any of the active-tracking based systems denoted as (A1) through (A10) may further include an image processing module for merging at least a portion of the mirror image with a second image to produce a merged image.

(A12) The active-tracking based system denoted as (A11) may further include a link for receiving the second image.

(A13) Either or both of the active-tracking based systems denoted as (A11) and (A12) may further include a display for displaying the merged image.

(A14) In any of the active-tracking based systems denoted as (A1) through (A13), the camera module may include a plurality of camera devices for generating a three-dimensional image, and the mirror image may be a three-dimensional mirror image.

(A15) In any of the active-tracking based systems denoted as (A1) through (A14), the camera module may be adapted to determine, from the position, a viewing direction associated with the mirror image.

(A16) In any of the active-tracking based systems denoted as (A1) through (A15), the camera module may include at least one camera device for generating an image of the observer.

(A17) Any of the active-tracking based systems denoted as (A1) through (A16) may further include a control system for controlling viewing direction associated with image generated by at least one camera device of the camera module.

(B1) An active-tracking based method for generating a mirror image may include (a) determining position of an observer relative to a surface, (b) capturing at least one image, and (c) generating, from the at least one image, the mirror image as the mirror image would have been experienced by the observer if the surface had been a mirror.

(B2) In the active-tracking based method denoted as (B1), the step of determining may include determining the position using at least one position sensor.

(B3) Either or both of the active-tracking based methods denoted as (B1) and (B2) may further include displaying the mirror image on a display.

(B4) In the active-tracking based method denoted as (B3), the step of displaying may include displaying the mirror image on a display coinciding with the surface.

(B5) In any of the active-tracking based methods denoted as (B1) through (B4), the step of capturing may include (i) orienting, according to the position of the observer, at least one camera along viewing direction associated with the mirror image, and (ii) capturing the at least one image along the viewing direction.

(B6) The active-tracking based method denoted as (B5) may further include determining the viewing direction based upon the position of the observer.

(B7) In any of the active-tracking based methods denoted as (B1) through (B6), the step of capturing may include capturing a plurality of images, using a respective plurality of camera devices located at a respective plurality of different locations, and the step of generating may include synthesizing the mirror image from the plurality of images.

(B8) The active-tracking based method denoted as (B7) may further include determining, based upon the position of the observer, a viewing direction associated with the mirror image, and the step of generating may include synthesizing the mirror image as an image along the viewing direction.

(B9) Any of the active-tracking based methods denoted as (B1) through (B8) may further include merging the mirror image with a second image to produce a merged image.

(B10) In the active-tracking based method denoted as (B9), in the step of merging, the second image may be a prerecorded image.

(B11) In the active-tracking based method denoted as (B9), in the step of merging, the second image being based upon image capture that is substantially simultaneously with capture of the at least one image in the step of capturing.

(B12) In the active-tracking based method denoted as (B11), in the step of merging, the second image may include a remote observer and the merged image may show the remote observer in environment of the observer.

(B13) The active-tracking based method denoted as (B12) may further include controlling view in remote environment associated with the remote observer.

(B14) Any of the active-tracking based methods denoted as (B1) through (B13) may further include capturing an observer image of the observer, and communicating the observer image to a remote display system.

(B15) The active-tracking based method denoted as (B14) may further include (1) in the step of capturing at least one image, capturing a time series of images to generate a three-dimensional model of the observer, and (2) in the step of merging, utilizing the three-dimensional model to show the remote observer in the merged image.

(B16) Any of the active-tracking based methods denoted as (B1) through (B15) may include repeating the steps of determining, capturing, and generating to actively track the observer and generate a corresponding stream of mirror images.

List of Exemplary Embodiments of Active-Tracking Vehicular-Based Systems and Methods for Generating a Mirror-Like (or Adaptive) Image:

(C1) An active-tracking vehicular-based system for generating a mirror-like (or adaptive) image may include (a) an addressable display comprising a display surface, (b) a position sensing module for determining position of an observer relative to the display surface, and (c) a camera module for generating the mirror-like image based upon the observer position, as the mirror image would have been experienced by the observer if at least part of the display surface had been a mirror.

(C2) An active-tracking vehicular-based system for generating a mirror-like (or adaptive) image may include (a) an addressable display having a display surface, (b) a position sensing module for determining position of an observer relative to the display surface, (c) a gaze sensing module for determining the observer's gaze direction relative to the display surface, and (d) a camera module for generating the mirror-like image based upon the observer position and gaze direction, as the mirror image would have been experienced by the observer if at least part of the display surface had been a mirror.

(C3) An active-tracking vehicular-based system for generating a mirror-like (or adaptive) image may include (a) a virtual or physical observation surface, (b) an addressable display comprising a display surface, (c) a virtual mirror surface, (d) a position sensing module for determining position of an observer relative to the observation surface, (e) a gaze sensing module for determining the observer's gaze direction relative to the observation surface, and (f) a camera module for generating the mirror-like (or adaptive) image based upon the observer position and gaze direction, as the mirror image would have been experienced by the observer if the virtual mirror surface had been a mirror.

(C4) In the system denoted as (C3), the observation surface may coincide with the display surface.

(C5) In either or both of the systems denoted as (C3) and (C4), the virtual mirror surface may include at least part of the display surface.

(C6) An active-tracking vehicular-based system for generating a mirror-like (or adaptive) image may include (a) a virtual or physical observation surface, (b) an addressable display comprising a display surface, (c) a virtual mirror surface, (d) a position sensing module for determining position of an observer relative to the observation surface, (e) a gaze sensing module for determining the observer's gaze direction relative to the observation surface, and (f) a camera module for generating the mirror-like (or adaptive) image based upon the observer position and gaze direction.

(C7) In the system denoted as (C6), at least a portion of the mirror-like (or adaptive) image may correspond to the scene that the observer would have seen when looking in a direction generally opposite the direction of vehicular travel.

(C8) In either or both of the systems denoted as (C6) and (C7), the mirror-like (or adaptive) image may also include image data pertaining to the vehicle's immediate sides and back surroundings.

(C9) In any of the systems denoted as (C6) through (C7), the mirror-like (or adaptive) image may also include a graphics image overlay.

(C10) An active-tracking vehicular-based system for generating a synthesized image may include (a) a virtual or physical observation surface, (b) an addressable display comprising a display surface, (c) a position sensing module for determining position of an observer relative to the observation surface, (d) a gaze sensing module for determining the observer's gaze direction relative to the observation surface, and (e) a camera module for generating the synthesized image based upon the observer position and gaze direction.

(C11) In the system denoted as (C10), at least a portion of the mirror-like (or adaptive) image may correspond to the scene that the observer would have seen by looking in a direction generally opposite the direction of vehicular travel.

Changes may be made in the above systems and methods without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and systems, which, as a matter of language, might be said to fall therebetween.

What is claimed is:

1. An active-tracking vehicular-based system for generating an adaptive image, comprising:
a position sensing module for determining position of an observer relative to a first surface; and
a camera module for generating the adaptive image, based upon the position, such that the adaptive image shows a scene as would have been experienced by the observer if at least part of the first surface had been a mirror.

2. The active-tracking vehicular-based system of claim 1, further comprising an addressable display for displaying the adaptive image.

3. The active-tracking vehicular-based system of claim 2, the first surface including at least a portion of display surface of the addressable display.

4. The active-tracking vehicular-based system of claim 2, the first surface being separate from display surface of the addressable display.

5. The active-tracking vehicular-based system of claim 1, the first surface being a virtual surface.

6. An active-tracking vehicular-based system for generating an adaptive image, comprising:
a position sensing module for determining position of an observer, positioned in or on a vehicle, relative to a first surface;
a gaze direction sensing module for determining gaze direction of the observer relative to the first surface; and
a camera module for generating the adaptive image, based upon the position and the gaze direction, such that the adaptive image shows a scene as would have been experienced by the observer if at least part of the first surface had been a mirror.

7. The active-tracking vehicular-based system of claim 6, further comprising an addressable display for displaying the adaptive image.

8. The active-tracking vehicular-based system of claim 7, the first surface including at least a portion of display surface of the addressable display.

9. The active-tracking vehicular-based system of claim 7, the first surface being separate from display surface of the addressable display.

10. The active-tracking vehicular-based system of claim 6, the first surface being a virtual surface.

11. The active-tracking vehicular-based system of claim 6, the camera module being configured for generating the adaptive image with image data pertaining to immediate surroundings of the vehicle.

12. The active-tracking vehicular-based system of claim 11, the camera module comprising a plurality of camera devices for capturing images and an image generation module for processing the images to produce the adaptive image.

13. The active-tracking vehicular-based system of claim 12, the camera devices and the image generation module being cooperatively configured to provide a 360-degree imagery of environment around the vehicle for use in the adaptive image.

14. The active-tracking vehicular-based system of claim 12, the camera devices and the image generation module being cooperatively configured to provide three-dimensional imagery of environment around the vehicle for use in the adaptive image.

15. The active-tracking vehicular-based system of claim 11, the plurality of cameras being oriented along a respective plurality of different viewing directions.

16. The active-tracking vehicular-based system of claim 6, further comprising an image processing module for merging, into the adaptive image, a graphics image overlay.

17. The active-tracking vehicular-based system of claim 6, the camera module comprising a computer for generating the adaptive image in real-time.

18. An active-tracking vehicular-based method for generating an adaptive image, comprising:
determining position of an observer, positioned in or on a vehicle, relative to a first surface;
determining gaze direction of the observer relative to the first surface;
capturing at least one image of environment surrounding the vehicle;
based upon the position and the gaze direction, generating an image of the environment as the environment would have been experienced by the observer if at least part of the first surface had been a mirror.

19. The active-tracking vehicular-based method of claim 18, the first surface being a virtual surface.

20. The active-tracking vehicular-based method of claim 18, further comprising:
in the step of capturing, capturing a first image of the environment along a first direction corresponding to reflection by the first surface of the gaze direction; and
in the step of generating, outputting the first image as the adaptive image.

21. The active-tracking vehicular-based method of claim 20, the step of capturing further comprising orienting viewing direction of a camera substantially along the first direction, based upon the gaze direction and the position.

22. The active-tracking vehicular-based method of claim 18, further comprising:
in the step of capturing, capturing a plurality of images of the environment; and
in the step of generating, synthesizing the adaptive image from the plurality of images.

23. The active-tracking vehicular-based method of claim 22, the step of synthesizing comprising producing a three-dimensional image of the environment.

24. The active-tracking vehicular-based method of claim 22, the step of synthesizing comprising:
producing 360-degree imagery of the environment; and
outputting the adaptive image as at least a portion of the 360-degree imagery.

25. The active-tracking vehicular-based method of claim 18, further comprising merging the adaptive image with at least one other image.

26. The active-tracking vehicular-based method of claim 18, further comprising merging the adaptive image with graphics data pertaining to the environment.

27. The active-tracking vehicular-based method of claim 18, further comprising displaying the adaptive image.

28. The active-tracking vehicular-based method of claim 27, the step of displaying comprising displaying the adaptive image on windshield of the vehicle.

29. The active-tracking vehicular-based method of claim 18, the step of capturing and generating cooperating to produce the adaptive image as corresponding to portion of the environment that the observer would have seen when looking in a direction generally opposite the direction of vehicular travel.
